(19) United States
(12) Patent Application Publication
(10) Pub. No.: US 2025/0106653 A1
(43) Pub. Date: Mar. 27, 2025

(54) TECHNIQUES FOR MODIFYING MACHINE LEARNING MODELS USING IMPORTANCE WEIGHTS

(71) Applicant: QUALCOMM Incorporated, San Diego, CA (US)

(72) Inventors: Mohamed Fouad Ahmed MARZBAN, San Diego, CA (US); Priyanka KASWAN, College Park, MD (US); Wooseok NAM, San Diego, CA (US); Sony AKKARAKARAN, Poway, CA (US)

(21) Appl. No.: 18/818,273

(22) Filed: Aug. 28, 2024

Related U.S. Application Data
(60) Provisional application No. 63/585,195, filed on Sep. 25, 2023.

(51) Int. Cl. H04W 24/02; G06N 20/00; H04L 41/16

(52) U.S. Cl. CPC H04W 24/02; G06N 20/00; H04L 41/16

(57) ABSTRACT

Methods, systems, and devices for wireless communication are described. A network node may calculate a set of weights for a first set of data associated with training a machine learning (ML) model in accordance with a first set of operating conditions for maintaining a communication link. Each weight of the set of weights may be associated with a respective datum of the first set of data and may be based on a probability that the respective datum is included in a second set of data. The second set of data may be associated with obtaining predictions using the machine learning model in accordance with a second set of operating conditions for maintaining the communication link. The network node may identify an event associated with the ML model and may output information indicative of the set of weights based on the event.

### CROSS REFERENCE

The present application for Patent claims the benefit of U.S. Provisional Patent Application No. 63/585,195 by MARZBAN et al., entitled “TECHNIQUES FOR MODIFYING MACHINE LEARNING MODELS USING IMPORTANCE WEIGHTS,” filed Sep. 25, 2023, assigned to the assignee hereof, and expressly incorporated by reference herein.

### TECHNICAL FIELD

The following relates to wireless communication, including techniques for modifying machine learning (ML) models using importance weights.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more network entities, each supporting wireless communication for communication devices, which may be known as user equipments (UEs).

### SUMMARY

The described techniques relate to improved methods, systems, devices, and apparatuses that support techniques for modifying machine learning (ML) models using importance weights. For example, the described techniques provide a framework for communicating importance weights between network nodes. In some examples, a network node may calculate a set of weights for a first set of data. The first set of data may be associated with training an ML model in accordance with a first set of operating conditions for maintaining a wireless communication link. Each weight of the set of weights may be associated with a respective datum of the first set of data. Additionally, each weight of the set of weights may be based on a probability that the respective datum is included in a second set of data. The second set of data may be associated with obtaining predictions using the ML model in accordance with a second set of operating conditions for maintaining the wireless communication link. In some examples, the network node may identify an event associated with the ML model. In such examples, the network node may output information indicative of the set of weights based on the event.

A method for wireless communication by a network node is described. The method may include calculating a set of weights for a first set of data associated with training a ML model in accordance with a first set of operating conditions for maintaining a wireless communication link, where each weight of the set of weights is associated with a respective datum of the first set of data, and where each weight of the set of weights is based on a probability that the respective datum is included in a second set of data, the second set of data being associated with obtaining predictions using the ML model in accordance with a second set of operating conditions for maintaining the wireless communication link, identifying an event associated with the ML model, and outputting information indicative of the set of weights based on identifying the event.

An apparatus for wireless communications is described. The apparatus may include at least one processor, memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) to cause the apparatus to calculate a set of weights for a first set of data associated with training a ML model in accordance with a first set of operating conditions for maintaining a wireless communication link, where each weight of the set of weights is associated with a respective datum of the first set of data, and where each weight of the set of weights is based on a probability that the respective datum is included in a second set of data, the second set of data being associated with obtaining predictions using the ML model in accordance with a second set of operating conditions for maintaining the wireless communication link, identify an event associated with the ML model, and output information indicative of the set of weights based on identifying the event.

A network node for wireless communication is described. The network node may include one or more memories storing processor executable code, and one or more processors coupled with the one or more memories. The one or more processors may individually or collectively operable to execute the code to cause the network node to calculate a set of weights for a first set of data associated with training a ML model in accordance with a first set of operating conditions for maintaining a wireless communication link, where each weight of the set of weights is associated with a respective datum of the first set of data, and where each weight of the set of weights is based on a probability that the respective datum is included in a second set of data, the second set of data being associated with obtaining predictions using the ML model in accordance with a second set of operating conditions for maintaining the wireless communication link, identify an event associated with the ML model, and output information indicative of the set of weights based on identifying the event.

Another network node for wireless communication is described. The network node may include means for calculating a set of weights for a first set of data associated with training a ML model in accordance with a first set of operating conditions for maintaining a wireless communication link, where each weight of the set of weights is associated with a respective datum of the first set of data, and where each weight of the set of weights is based on a probability that the respective datum is included in a second set of data, the second set of data being associated with obtaining predictions using the ML model in accordance with a second set of operating conditions for maintaining the wireless communication link, means for identifying an event associated with the ML model, and means for outputting information indicative of the set of weights based on identifying the event.

A non-transitory computer-readable medium storing code for wireless communications at a UE is described. The code may include instructions executable by at least one processor (e.g., directly, indirectly, after pre-processing, without pre-processing) to calculate a set of weights for a first set of data associated with training a ML model in accordance with a first set of operating conditions for maintaining a wireless communication link, where each weight of the set of weights is associated with a respective datum of the first set of data, and where each weight of the set of weights is based on a probability that the respective datum is included in a second set of data, the second set of data being associated with obtaining predictions using the ML model in accordance with a second set of operating conditions for maintaining the wireless communication link, identify an event associated with the ML model, and output information indicative of the set of weights based on identifying the event.

In some examples of the method, apparatus, network nodes, and non-transitory computer-readable medium described herein, identify the event may include operations, features, means, or instructions for identifying data drift associated with the ML model, where the data drift corresponds to a difference between the first set of data and the second set of data, and where calculating the set of weights may be based on identifying the data drift.

In some examples of the method, apparatus, network nodes, and non-transitory computer-readable medium described herein, outputting the information may include operations, features, means, or instructions for outputting the information to a user equipment (UE), where the ML model may be used at the UE for obtaining the predictions using the ML model.

In some examples of the method, apparatus, network nodes, and non-transitory computer-readable medium described herein, the information indicative of the set of weights includes first information indicative of each weight of the set of weights or includes second information indicative of a portion of the set of weights, the portion of the set of weights being associated with a respective portion of the first set of data.

In some examples of the method, apparatus, network nodes, and non-transitory computer-readable medium described herein, the information indicative of the set of weights includes first information indicative of statistics corresponding to the set of weights.

In some examples of the method, apparatus, network nodes, and non-transitory computer-readable medium described herein, the network node includes a UE and the ML model may be used at the UE for obtaining the predictions using the ML model.

In some examples of the method, apparatus, network nodes, and non-transitory computer-readable medium described herein, outputting the information may include operations, features, means, or instructions for outputting the information based on a statistical property associated with the set of weights satisfying a condition.

In some examples of the method, apparatus, network nodes, and non-transitory computer-readable medium described herein, outputting the information may include operations, features, means, or instructions for outputting the information to a second UE associated with the second set of operating conditions.

In some examples of the method, apparatus, network nodes, and non-transitory computer-readable medium described herein, identify the event may include operations, features, means, or instructions for identifying a handover of a UE from a first cell to a second cell, where the information may be output to the UE within a duration associated with the handover.

In some examples of the method, apparatus, network nodes, and non-transitory computer-readable medium described herein, identifying the event may include operations, features, means, or instructions for monitoring a metric associated with a performance of the ML model and determining that the metric satisfies a threshold, where calculating the set of weights is based on the metric satisfying the threshold.

In some examples of the method, apparatus, network nodes, and non-transitory computer-readable medium described herein, the metric includes a prediction accuracy metric, a system performance metric, or a data distribution metric.

In some examples of the method, apparatus, network nodes, and non-transitory computer-readable medium described herein, identify the event may include operations, features, means, or instructions for obtaining a request for weights associated with training the ML model, where outputting the information may be in response to obtaining the request.

Some examples of the method, apparatus, network nodes, and non-transitory computer-readable medium described herein may further include operations, features, means, or instructions for outputting control signaling including a configuration to calculate the set of weights, the configuration indicative of a set of parameters for calculating the set of weights, where calculating the set of weights may be in accordance with the set of parameters and based on operating conditions for maintaining the wireless communication link.

In some examples of the method, apparatus, network nodes, and non-transitory computer-readable medium described herein, the set of parameters may be based on a scheme used for the weight calculations and the scheme includes a kernel density estimation (KDE), a discriminative learning, or a kernel mean matching.

Some examples of the method, apparatus, network nodes, and non-transitory computer-readable medium described herein may further include operations, features, means, or instructions for outputting, in response to statistics corresponding to the set of weights exceeding a threshold, control signaling comprising a configuration to switch from calculating the set of weights associated with the ML model to calculating the set of weights based on a second ML model or new data, or switch from calculating the set of weights associated with the ML model to calculating the set of weights without using a ML model.

Some examples of the method, apparatus, network nodes, and non-transitory computer-readable medium described herein may further include operations, features, means, or instructions for identifying a variation in statistics corresponding to the set of weights, and outputting control signaling including a configuration to calculate the set of weights without a request to collect new data for calculating the set of weights.

Some examples of the method, apparatus, network nodes, and non-transitory computer-readable medium described herein may further include operations, features, means, or instructions for obtaining a report indicative of a recommendation to recalculate the set of weights, and outputting the information indicative of the recalculated set of weights based on the recommendation.

A method for wireless communication by a network node is described. The method may include obtaining information indicative of a set of weights for a first set of data associated with training a ML model in accordance with a first set of operating conditions for maintaining a wireless communication link, where each weight of the set of weights is associated with a respective datum of the first set of data, and where each weight of the set of weights is based on a probability that the respective datum is included in a second set of data, the second set of data being associated with obtaining predictions using the ML model in accordance with a second set of operating conditions for maintaining the wireless communication link, modifying the ML model based on the information, and obtaining a prediction pertaining to the wireless communication link using the modified ML model.

An apparatus for wireless communications is described. The apparatus may include at least one processor, memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) to cause the apparatus to obtain information indicative of a set of weights for a first set of data associated with training a ML model in accordance with a first set of operating conditions for maintaining a wireless communication link, where each weight of the set of weights is associated with a respective datum of the first set of data, and where each weight of the set of weights is based on a probability that the respective datum is included in a second set of data, the second set of data being associated with obtaining predictions using the ML model in accordance with a second set of operating conditions for maintaining the wireless communication link, modify the ML model based on the information, and obtain a prediction pertaining to the wireless communication link using the modified ML model.

A network node for wireless communication is described. The network node may include one or more memories storing processor executable code, and one or more processors coupled with the one or more memories. The one or more processors may individually or collectively operable to execute the code to cause the network node to obtain information indicative of a set of weights for a first set of data associated with training a ML model in accordance with a first set of operating conditions for maintaining a wireless communication link, where each weight of the set of weights is associated with a respective datum of the first set of data, and where each weight of the set of weights is based on a probability that the respective datum is included in a second set of data, the second set of data being associated with obtaining predictions using the ML model in accordance with a second set of operating conditions for maintaining the wireless communication link, modify the ML model based on the information, and obtain a prediction pertaining to the wireless communication link using the modified ML model.

Another network node for wireless communication is described. The network node may include means for obtaining information indicative of a set of weights for a first set of data associated with training a ML model in accordance with a first set of operating conditions for maintaining a wireless communication link, where each weight of the set of weights is associated with a respective datum of the first set of data, and where each weight of the set of weights is based on a probability that the respective datum is included in a second set of data, the second set of data being associated with obtaining predictions using the ML model in accordance with a second set of operating conditions for maintaining the wireless communication link, means for modifying the ML model based on the information, and means for obtaining a prediction pertaining to the wireless communication link using the modified ML model.

A non-transitory computer-readable medium storing code for wireless communications at a UE is described. The code may include instructions executable by at least one processor (e.g., directly, indirectly, after pre-processing, without pre-processing) to obtain information indicative of a set of weights for a first set of data associated with training a ML model in accordance with a first set of operating conditions for maintaining a wireless communication link, where each weight of the set of weights is associated with a respective datum of the first set of data, and where each weight of the set of weights is based on a probability that the respective datum is included in a second set of data, the second set of data being associated with obtaining predictions using the ML model in accordance with a second set of operating conditions for maintaining the wireless communication link, modify the ML model based on the information, and obtain a prediction pertaining to the wireless communication link using the modified ML model.

Some examples of the method, apparatus, network nodes, and non-transitory computer-readable medium described herein may further include operations, features, means, or instructions for determining that a statistical property associated with the set of weights satisfies a condition and refraining from obtaining a second prediction pertaining to the wireless communication link using the ML model based on the statistical property satisfying the condition.

In some examples of the method, apparatus, network nodes, and non-transitory computer-readable medium described herein, modifying the ML model may include operations, features, means, or instructions for switching the ML model from a first ML model associated with the first set of operating conditions to a second ML model associated with the second set of operating conditions based on determining that a statistical property associated with the set of weights satisfies a condition.

In some examples of the method, apparatus, network nodes, and non-transitory computer-readable medium described herein, modifying the ML model may include operations, features, means, or instructions for training the ML model using a third set of data associated with the second set of operating conditions based at least on part on determining that a statistical property associated with the set of weights satisfies a condition.

In some examples of the method, apparatus, network nodes, and non-transitory computer-readable medium described herein, modifying the ML model may include operations, features, means, or instructions for re-training the ML model using the set of weights.

Some examples of the method, apparatus, network nodes, and non-transitory computer-readable medium described herein may further include operations, features, means, or instructions for outputting the information to at least one other node associated with the second set of operating conditions.

Some examples of the method, apparatus, network nodes, and non-transitory computer-readable medium described herein may further include operations, features, means, or instructions for outputting a request for weights associated with training the ML model, where obtaining the information may be in response to the request.

Some examples of the method, apparatus, network nodes, and non-transitory computer-readable medium described herein may further include operations, features, means, or instructions for identifying data drift associated with the ML model, where the data drift corresponds to a difference between the first set of data and the second set of data, and where outputting the request may be based on identifying the data drift.

Some examples of the method, apparatus, network nodes, and non-transitory computer-readable medium described herein may further include operations, features, means, or instructions for identifying a change in a performance of the ML model within a duration, where outputting the request may be based on identifying the change.

In some examples of the method, apparatus, network nodes, and non-transitory computer-readable medium described herein, the set of weights may be based on data drift associated with the ML model, the data drift corresponding to a difference between the first set of data and the second set of data.

In some examples of the method, apparatus, network nodes, and non-transitory computer-readable medium described herein, the information includes first information indicative of each weight of the set of weights or includes second information indicative of a portion of the set of weights, the portion of the set of weights being associated with a respective portion of the first set of data.

In some examples of the method, apparatus, network nodes, and non-transitory computer-readable medium described herein, the information includes first information indicative of statistics corresponding to the set of weights.

In some examples of the method, apparatus, network nodes, and non-transitory computer-readable medium described herein, obtaining the information may include operations, features, means, or instructions for obtaining the information based on a statistical property associated with the set of weights satisfying a condition.

In some examples of the method, apparatus, network nodes, and non-transitory computer-readable medium described herein, obtaining the information may include operations, features, means, or instructions for obtaining the information from a second network node associated with the second set of operating conditions.

In some examples of the method, apparatus, network nodes, and non-transitory computer-readable medium described herein, obtaining the information may include operations, features, means, or instructions for obtaining the information within a duration associated with a handover of the network node from a first cell to a second cell.

In some examples of the method, apparatus, network nodes, and non-transitory computer-readable medium described herein, obtaining the information may include operations, features, means, or instructions for obtaining the information based on a metric associated with a performance of the ML model satisfying a threshold.

In some examples of the method, apparatus, network nodes, and non-transitory computer-readable medium described herein, the metric includes a prediction accuracy metric, a system performance metric, or a data distribution metric.

### BRIEF DESCRIPTION OF THE DRAWINGS

FIG. 1 shows an example of a wireless communications system that supports techniques for modifying machine learning (ML) models using importance weights in accordance with one or more aspects of the present disclosure.

FIG. 2 shows an example of a network architecture that supports techniques for modifying ML models using importance weights in accordance with one or more aspects of the present disclosure.

FIG. 3 shows an example of a wireless communications system that supports techniques for modifying ML models using importance weights in accordance with one or more aspects of the present disclosure.

FIGS. 4 and 5 each show an example of a process flow that supports techniques for modifying ML models using importance weights in accordance with one or more aspects of the present disclosure.

FIGS. 6 and 7 show block diagrams of devices that support techniques for modifying ML models using importance weights in accordance with one or more aspects of the present disclosure.

FIG. 8 shows a block diagram of a communications manager that supports techniques for modifying ML models using importance weights in accordance with one or more aspects of the present disclosure.

FIG. 9 shows a diagram of a system including a UE that supports techniques for modifying ML models using importance weights in accordance with one or more aspects of the present disclosure.

FIG. 10 shows a diagram of a system including a network entity that supports techniques for modifying ML models using importance weights in accordance with one or more aspects of the present disclosure.

FIGS. 11 and 12 show flowcharts illustrating methods that support techniques for modifying ML models using importance weights in accordance with one or more aspects of the present disclosure.

### DETAILED DESCRIPTION

A wireless communications system may support artificial intelligence (AI) and machine learning (ML). For example, the wireless communication system may include one or more network nodes that use AI/ML models for inferences regarding wireless communications within the wireless communications system. A network node may deploy an AI/ML model in the wireless communication system to infer a measurement (e.g., received power measurement, an interference measurement) associated with a communication resource based on a previous measurement. Prior to deploying the AI/ML model, the network node (or another network node) may train the AI/ML model for use in a particular environment or under particular operating conditions. For example, the network node may intend to deploy the AI/ML model in an environment with the first operating conditions and, as such, may train the AI/ML model on data that is representative of the first operating conditions. In some examples, however, the network node may use the AI/ML model in accordance with second operating conditions, which may be different from the first operating conditions. For example, the environment of the network node may change such that current operating conditions of the network node (e.g., the second operating conditions) may be different from the operating conditions for which the AI/ML model was training (e.g., the first operating conditions). In such an example, a performance of the AI/ML model may be degraded. That is, the AI/ML model may be inapplicable to the second operating conditions and, as a result, inferences made using the AI/ML model in accordance with the second operating conditions may be relatively inaccurate. In such an example, the network node may determine to re-train the AI/ML model using data representative of the second operating conditions. In some examples, however, data collection and re-training may lead to increased overhead and latency for the network node.

Various aspects of the present disclosure generally relate to techniques for modifying AI/ML models using importance weight and, more specifically, to a framework for communicating importance weights between network nodes. For example, a first network node may deploy an AI/ML model in an environment with first operating conditions. The AI/ML model may be trained (e.g., prior to deployment) using training data associated with the first operating conditions. The first network node (or a second network node) may detect a change in the applicability of the AI/ML model to the environment of the first network node. For example, the first network node (or the second network node) may determine that the operating conditions of the environment changed from the first operating conditions to second operating conditions. In response to detecting the change in the applicability of the AI/ML model, the first network node may obtain importance weights for the training data. For instance, the second network node may calculate the importance weights and indicate the importance weights to the first network node. In some examples, the first network node may request the importance weights from the second network node.

The importance weights may weigh the training data such that the training data (e.g., the weighted training data) may be representative of the second operating conditions. For example, each importance weight may correspond to a respective piece of training data (e.g., datum) and may represent a likelihood of the piece of training data occurring in inference data (e.g., data input into the AI/ML model to obtain an inference) associated with the second operating conditions. As an illustrative example, a value of an importance weight for a received power measurement may be proportional to a likelihood of the first network node measuring the received power under the second operating conditions. The first network node may therefore use the importance weights to re-train the AI/ML model using the (same) training data. In some examples, the first network node may indicate the importance weights to one or more other network nodes, such as network nodes that may operate under relatively similar conditions (e.g., conditions similar to the second operating conditions). In some examples, re-training the AI/ML model using the importance weights may reduce data collection, which may lead to reduce latency and overhead, among other benefits.

Aspects of the disclosure are initially described in the context of wireless communications systems, a network architecture, and process flows. Aspects of the disclosure are further illustrated by and described with reference to apparatus diagrams, system diagrams, and flowcharts that relate to techniques for modifying ML models using importance weights.

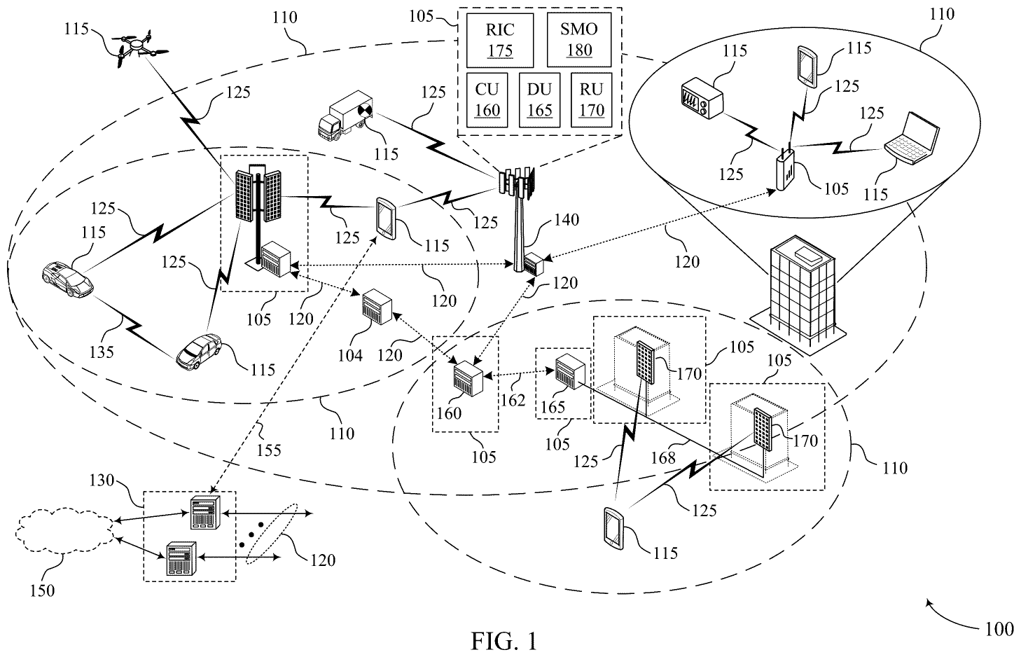

FIG. 1 shows an example of a wireless communications system 100 that supports techniques for modifying ML models using importance weights in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

UEs 115 may be dispersed throughout the wireless communications system 100 (e.g., may be dispersed throughout a coverage area 110 of the wireless communications system 100), and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1. For example, a UE 115 may also be referred to as a mobile device, a wireless device, a remote device, a handheld device, or a subscriber device, or some other suitable terminology, where the “device” may also be referred to as a unit, a station, a terminal, or a client. A UE 115 may be a device such as a cellular phone, a smart phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may also refer to a wireless local loop (WLL) station, an Internet of Things (IoT) device, an Internet of Everything (IoE) device, or an MTC device, or the like, which may be implemented in various articles such as appliances, drones, robots, vehicles, meters, or the like.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for modifying ML models using importance weights as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay that information to a central server or application program that uses (e.g., that can make use of) the information or present the information to humans interacting with the program or application. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may include one or more network nodes that use AL/ML models for inferences regarding wireless communications within the wireless communications system 100. For example, a network node (e.g., a UE 115, a network entity 105, a core network 130) may deploy an AI/ML model in the wireless communication system 100 to infer a measurement associated with a communication resource based on a previous measurement. The network node may intend to deploy the AI/ML model in an environment associated with the first operating conditions and, as such, may train the AI/ML model on data that is representative of the first operating conditions. The environment of the network node may change such that current operating conditions of the network node (e.g., the second operating conditions) may be different from the operating conditions for which the AI/ML model was training (e.g., the first operating conditions). In such an example, the AI/ML model may be inapplicable to the second operating conditions and, as a result, inferences made using the AI/ML model may be relatively inaccurate. Accordingly, the network node may determine to re-train the AI/ML model using other training data representative of the second operating conditions. In some examples, however, data collection and re-training may lead to increased overhead and latency for the network node.

In some other examples, the network node may re-train the AI/ML model using importance weight. For example, the network node (or another network node) may detect a change in the applicability of the AI/ML model to the environment of the network node. In response to the change in the applicability of the AI/ML model, the network node may obtain importance weights for the training data (e.g., from the other network node, which may be another UE 115, another network entity 105, another core network 130). Each importance weight may correspond to a respective datum of the training data and may represent a likelihood of the datum occurring in inference data (e.g., data input into the AI/ML model to obtain an inference) associated with the second operating conditions. The network node may use the importance weights to modify (e.g., re-train) the AI/ML model using the training data. Re-training the AI/ML model using the importance weights may reduce data collection, which may lead to reduce latency and overhead within the wireless communications system 100, among other benefits.

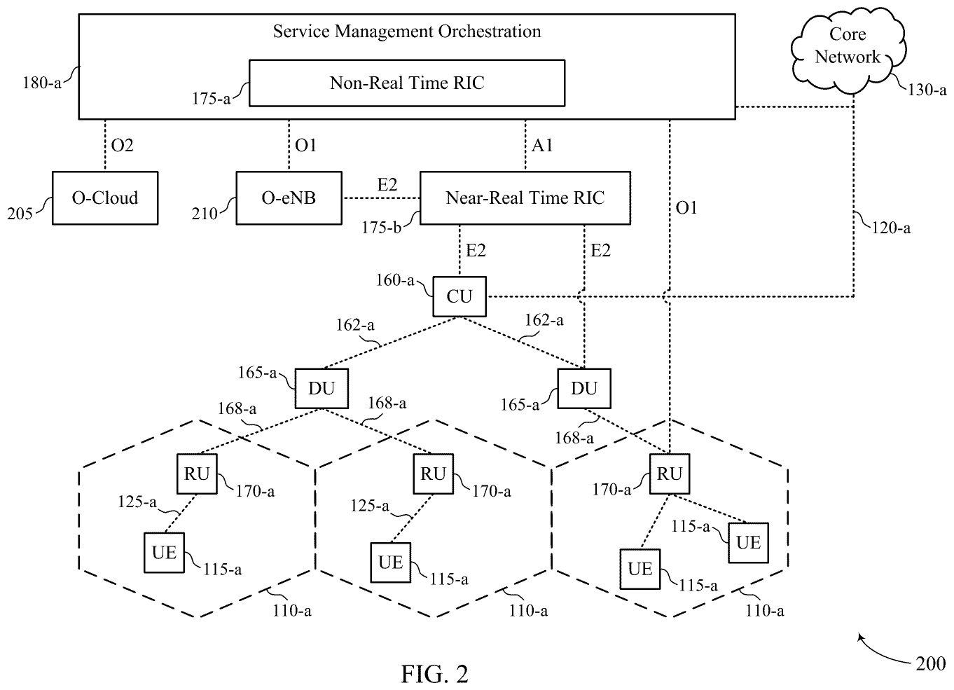

FIG. 2 shows an example of a network architecture 200 (e.g., a disaggregated base station architecture, a disaggregated RAN architecture) that supports techniques for modifying ML models using importance weights in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., A1 policies).

The network architecture 200 may support a framework for communicating importance weights between network nodes. For example, a first network node (e.g., a UE 115-a, a DU 165-a, or one of the O-eNB 210, the CU 160-a, the Non-RT RIC 175-a, the Near-RT RIC 175-b, or the core network 130-a) may calculate a set of weights for a first set of data associated with training an AI/ML model (e.g., training data) in accordance with a first set of operating conditions for maintaining a communication link. The communication link may be an example of a communication link 125-a, a fronthaul communication link 168-a, a midhaul communication link 162-a, a backhaul communication link 120-a, an O1 interface, an A1 interface, an E2 interface, or a communication link 120-a, among other examples of communication links. Each weight of the set of weights may be associated with a respective datum of the first set of data. Additionally, each weight of the set of weights may be based on a probability that the respective datum is included in a second set of data associated with obtaining predictions using the ML model in accordance with a second set of operating conditions for maintaining the communication link.

The first network node (or a second network node) may identify an event associated with the AI/ML model. For example, the first network node may detect a change in the environment of the second network node (e.g., another UE 115-a, another DU 165-a, or another one of the O-eNB 210, the CU 160-a, the Non-RT RIC 175-a, the Near-RT RIC 175-b, or the core network 130-a), which may have deployed the AI/ML model. In such an example, the first network node may output information indicative of the set of weights to the second network node (e.g., based on identifying the event). The second network node may modify the AI/ML model based on the information. In some examples, the second network node may obtain a prediction pertaining to the communication link (or a wireless communications system implementing the network architecture 200) using the modified AI/ML model.

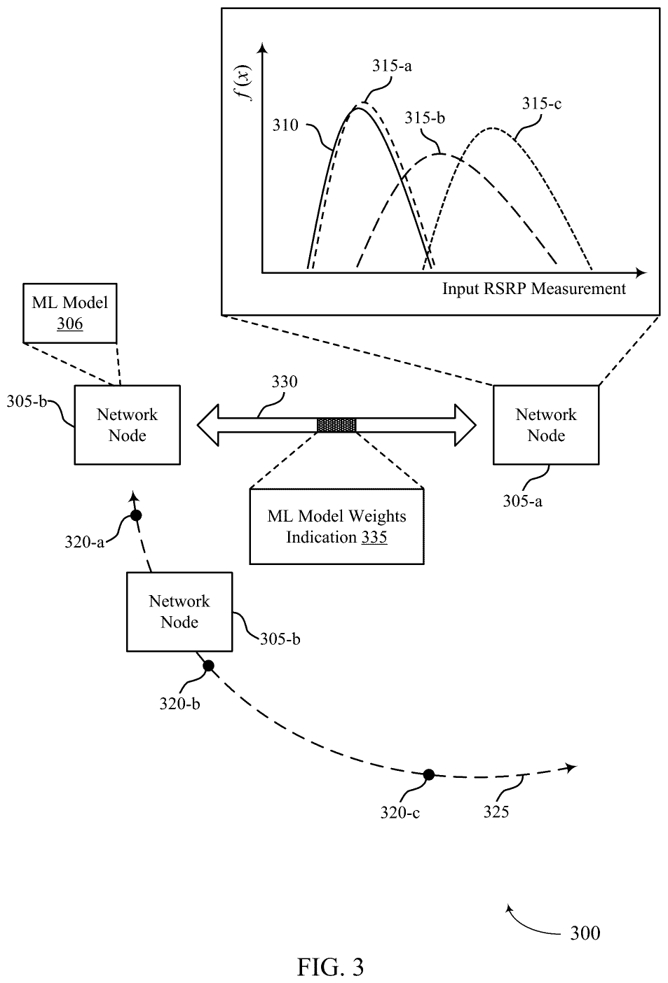

FIG. 3 shows an example of a wireless communications system 300 that supports techniques for modifying ML models using importance weights in accordance with one or more aspects of the present disclosure. In some examples, the wireless communications system 300 may implement or be implemented at one or more aspects of the wireless communications system 100 and the network architecture 200. For example, the wireless communications system 300 may include a network node 305-a and a network node 305-b. The network nodes 305 may each be an example of a UE 115 or a network entity 105 (e.g., a CU, a DU, an RU, a base station, an IAB node, or one or more other network nodes) illustrated by and described with reference to FIGS. 1 and 2. For example, the network nodes 305 may each be an example of a gNB, a location management function (LMF), a RIC, or a UE (e.g., a hub UE, an anchor UE, a coordinator UE). The network nodes 305 may communicate via a communication link 330, which may be an example of one or more communication links illustrated by and described with reference to FIGS. 1 and 2. For example, the communication link 330 may be an example of a communication link 125 (e.g., a Uu link), a communication link 135 (e.g., a sidelink, also referred to as a PC5 interface), or communication link 155. Additionally, or alternatively, the communication link 330 may be an example of a fronthaul communication link 168, a midhaul communication link 162, or a backhaul communication link 120 illustrated by and described with reference to FIGS. 1 and 2.

As illustrated in the example of FIG. 3, the network node 305-b may support an ML model 306. Although illustrated in the example of FIG. 3 as being associated with the network node 305-b, the ML model 306 may also be associated with the network node 305-a. That is, the ML model 306 may be deployed (or trained) at one or both of the network nodes 305. For example, one or both of the network nodes 305 may train the ML model 306 and then deploy the ML model 306 to make one or more predictions (e.g., inferences). In some examples, the network nodes 305 may make one or more determinations based on the predictions obtained using the ML model 306. For example, the network nodes 305 may use the ML model 306 to predicted channel characteristics (e.g., properties or characteristics for maintaining the communication link 330) and, based on the predicted channel characteristics, one or both of the network nodes 305 may make one or more determinations. Such determinations may include determinations regarding beam management (e.g., may select a beam for communications via the communication link 330). Additionally, or alternatively, such determination may include determinations regarding model selection, activation, deactivation, switching, and fallback operations, among other examples. As such, one or both of the network nodes 305 may monitor a performance of the ML model 306. In other words, the network nodes 305 may support ML model monitoring.

For example, one or both of the network nodes 305 may monitor the ML model 306 for a mismatch (e.g., any mismatch) between inference data and training data. As described herein, inference data may refer to data used with the ML model 306 to infer (e.g., predict) a property, such as a channel characteristic. For example, the network node 305-b may use the ML model 306 to predict channel characteristics (e.g., RSRP measurements, SINR measurements) based on inference data, which may include previous (e.g., historic) channel characteristics (e.g., previous RSRP measurement, previous SINR measurements). Additionally, as described herein, training data may refer to data used to train the ML model 306 (e.g., to make predictions using the inference data). For example, the network node 305-b may intend (e.g., expect) to use (e.g., deploy) the ML model 306 in a particular environment with particular operating conditions (e.g., particular received power levels, a particular scheduling mode, a particular reference signal type, a particular bandwidth, particular antenna ports). In some examples, the network node 305-b may intend to deploy the ML model 306 in an environment associated with a location 320-a. The environment associated with the location 320-a may be associated with first operating conditions and, as such, the network node 305-b may train the ML model 306 on a data set (e.g., a training data set) that is consistent with (representative of) the first operating conditions, such as a training data set (e.g., input RSRP measurements) with a training distribution 315-a. In other examples, the network node 305-b may intend to deploy the ML model 306 in an environment associated with a location 320-b. The environment associated with the location 320-b may be associated with second operating conditions and, as such, the network node 305-b may train the ML model 306 on a training data set that is consistent with the second operating conditions, such as a training data set with a training distribution 315-b. In some other examples, the network node 305-b may intend to deploy the ML model 306 in an environment associated with a location 320-c. The environment associated with the location 320-c may be associated with third operating conditions and, as such, the network node 305-b may train the ML model 306 on a training data set that is consistent with the third operating conditions, such as a training data set with a training distribution 315-c.

Operating conditions of the network node 305-b may change, for example, based on the environment of the network node 305-b. As illustrated in the example of FIG. 3, the network node 305-b may be mobile (e.g., capable of moving locations, rotating, or otherwise changing a position of the network node 305-b or one or more components of the network node 305-b) and the environment of the network node 305-b may change due to a change in the location (or position) of the network node 305-b. For example, as the network node 305-b moves along a path 325, the location of the network node 305-b may change among the location 320-a, the location 320-b, and the location 320-c. In some other examples, the environment of the network node 305-b may change due to one or more parameters of the surroundings of the network node 305-b changing (e.g., a density of objects or other devices within the surroundings of the network node 305-b changing). Additionally, or alternatively, the environment of the network node 305-b may change due to a location of the network node 305-a changing, among other factors which may impact the environment of the network node 305-b. In some examples, a change in the operating conditions (e.g., environment) of the network node 305-b may lead to a mismatch between inference data (e.g., the data used to make predictions using the ML model 306 after the ML model 306 has been deployed) and training data used train the ML model 306.

A mismatch between training data and inference data may be referred to as data drift or concept drift. For example, the ML model 306 may be trained using training data associated with the training distribution 315-b (e.g., desirable data distribution, a distribution of a training dataset used to train the ML model 306) for which the ML model 306 may be intended (e.g., designed) to operate. That is, the network node 305-b may expect to deploy the ML model 306 in an environment associated with the location 320-b and, as such, may train (e.g., prior to deployment) the ML model 306 using a training data set associated with the second operating conditions (e.g., operating conditions that the ML model 306 is intended to be deployed in) and the training data set may have a particular distribution (e.g., the training distribution 315-b). In some examples, however, the network node 305-b may deploy the ML model 306 in an environment with operating conditions that are different from the operating conditions that the network node 305-b intended to deploy the ML model 306 in. For example, the network node 305-b may deploy the ML model 306 at the location 320-a with first operating conditions that are different from the second operating conditions associated with the location 320-b. In such examples, a distribution of data used for inferences with the ML model 306 (e.g., an inference distribution 310, which may include input RSRP measurements) may deviate from (e.g., drift relative to, be mismatched from) the training distribution 315-b. That is the inference distribution 310 of the inference data used for making inferences (predictions) with the ML model 306 at the location 320-a may deviate from the training distribution 315-b of the training data used for training the ML model 306. In other words, the inference distribution 310 may have relatively low distribution similarity (e.g., no or relatively small overlap) with the training distribution 315-b. In some examples, a deviation of an inference distribution from a training distribution may be referred to as concept drift, learning under concept drift, covariate shift, or data-model mismatch.

Data drift may degrade a performance of the ML model 306. For example, the ML model 306 may operate in environments or with operating conditions that are different from the environment or operating conditions under which the ML model 306 has been trained (e.g., an environment associated with a location 320-a), which may degrade a performance of the ML model 306. As such, one or both of the network nodes 305 may monitor the ML model 306, for example, using one or more metrics. In other words, one or both of the network nodes 305 may support ML model monitoring to maintain a performance of the ML model 306 (e.g., in a relatively desirable operation scenario). In some examples, one or both of the network nodes 305 may perform one or more actions in response to detecting a data-model mismatch. For example, in response to detecting data-model mismatch for the ML model 306, one or both of the network nodes may switch between multiple (e.g., different) ML models, fallback to a non-ML mode baseline (e.g., refrain from using an ML model for inference of one or more channel characteristics), train a global ML model that generalizes relatively well under different environment, or re-training (e.g., finetune) the ML model 306.

The network nodes 305 may support one or more metrics or methods for AI/ML model monitoring in lifecycle management. For example, the network nodes 305 may support monitoring based on inference accuracy, including metrics related to intermediate key performance indicators (KPIs). In some examples, the network nodes 305 may support monitoring based on system performance, including metrics related to system performance KPIs. Additionally, or alternatively, the network nodes 305 may support one or more other monitoring solutions, such as monitoring based on data distribution (e.g., input-based, and output-based monitoring) and monitoring based on applicable conditions. Input-based monitoring may include monitoring a validity of the AI/ML input. For example, monitoring out-of-distribution detection, drift detection of input data, or monitoring SNR, or delay spread. Output-based monitoring may include monitoring for drift detection of output data. Model monitoring metric calculations may be performed at one or both of the network nodes 305 (e.g., may be done at the network or a UE).

Additionally, or alternatively, the network nodes 305 may support one or more performance monitoring approaches, which may consider one or more model monitoring KPIs (e.g., as general guidance). For example, the network nodes 305 may support performing monitoring based on accuracy and relevance (e.g., how well a given monitoring metric or methods reflects an ML model and system performance), overhead (e.g., signaling overhead associated with model monitoring), complexity (e.g., computation and memory cost for model monitoring), latency (e.g., timeliness of monitoring result, from model failure to action, given a purpose of model monitoring), and power consumption, among other KPIs. In some examples, one or more KPIs used for model monitoring may vary across multiple (e.g., different) model monitoring approaches. For example, one or more KPIs used for lifecycle management procedures may be different from one or more KPIs used for another ML model monitoring approach.

The network nodes 305 may support one or more types of AI/ML model monitoring approaches. For example, the network nodes 305 may support an intermediate performance monitoring approach in which the ML model 306 may be monitored based on one or more intermediate metrics. In some examples, an intermediate metric used for ML model monitoring may depend on a use case for the ML model 306. For example, the network node 305-b (or the network node 305-a) may use the ML model 306 for interference prediction. That is, the network node 305-b may use the ML model 306 to predict interference for a first resource (e.g., a future time and frequency resource used for transmission of one or more signals) based on interference measured on a second resource (e.g., a previous time and frequency resource). In such an example, the network node 305-b may perform ML model monitoring based on a mean square error (MSE) between the predicted interference for the first resource and an actual interference measured for the first resource. That is, in accordance with the ML model monitoring, the network node 305-b may determine the MSE between the predicted interference metric (e.g., obtained via the ML model 306) for the first resource and an actually measured interference metric for the first resource. In some examples, the MSE may be relatively high and, as such, the network node 305-b (or the network node 305-a) may determine that a performance of the ML model 306 is reduced (e.g., degraded). Additionally, or alternatively, the network node 305-b may perform ML model monitoring based on a top-k accuracy for a predicted interference class. For example, the network node 305-b may be configured with multiple interference classes (e.g., levels of interference, such as high interference, medium interference, low interference). In such an example, the network node 305-b may use the ML model 306 to predict an interference class for the first resource based on an interference class measured for the second resource.

Additionally, or alternatively, the network node 305-b (or the network node 305-a) may use the ML model 306 for beam prediction. In such an example, the network node 305-b may perform ML model monitoring based on reference signal received power (RSRP) differences, such as L1-RSRP difference, between measured RSRP beams and predicted RSRP beams. Additionally, or alternatively, the network node 305-b may perform ML model monitoring based on top-k beams prediction accuracy. That is, intermediate performance metrics may compare an RSRP difference or a top-k accuracy between one or more predicted beams (e.g., predicted best beams, beams predicted to have a highest received power or lowest interference level relative to one or more other beams) and one or more measured beams (e.g., measured best beams, beams measured to have a highest received power or lowest interference level relative to one or more other beams) at a prediction instance. For example, the network node 305-b may measure 4 beams (or some other suitable quantity of beams) in 3 consecutive 20 ms occasions (or some other suitable quantity of consecutive occasions of some other suitable quantity of time). In such an example, after 100 ms (e.g., at the prediction instance, which may occur 100 ms or some other suitable quantity of time after a last occasion of the 3 consecutive occasions) the network node 305-b may use the ML model 306 to predict a top beam (e.g., a best beam, a beam with a relatively highest received power or relatively lowest interference) based on the historical measurements of the 4 beams measured in the 3 consecutive 20 ms occasions. Additionally, or alternatively, the network node 305-b may perform one or more measurements to determine the top beam at the prediction instance (e.g., after 100 ms). In such an example, an intermediate performance metrics may compare the predicted top beam (e.g., the beam with beam index #1) and measured top beam (e.g., the beam with beam index #3) at the prediction instance (e.g., at the prediction time). In some examples, intermediate performance monitoring may provide an indication (e.g., a solid indication) on the ML model performance, for example, because intermediate performance monitoring evaluates the actual output of the ML model.

Additionally, or alternatively, the network nodes 305 may support an end-to-end performance monitoring approach in which the ML model 306 may be monitored based on end-to-end system performance metrices, such as throughput, user perceived throughout (UPT), and latency, among other examples performance metrics. As an illustrative example, the network node 305-b may measure 4 beams in 3 consecutive 20 ms occasions and, after 100 ms the network node 305-b may use the ML model 306 to predict a top beam (e.g., the beam with the beam index #1) based on the measurements of the 4 beams in the 3 consecutive 20 ms occasions. In such an example, the predicted top beam may lead to a particular throughput. End-to-end metrics for AI/ML model monitoring may enable the network node 305-b (or the network node 305-a) to monitor the throughput of the system over time and, as such, determine the applicability of the AI/ML model (e.g., over time).

Additionally, or alternatively, the network nodes 305 may support AI/ML model monitoring based on data distributions. For example, a model may be trained under a particular environment (e.g., indoor vs. outdoor scenarios, heavy vs. sparse traffic scenarios) or configuration, which may impact a distribution of the ML model inputs and outputs (ground-truth labels). During inference, by observing the input data distribution or joint input-output data distribution after inference, a monitoring algorithm may determine to switch the ML model or fallback to non-AI/ML operation. In some examples, AI/ML model monitoring based on the data distributions may include measuring distribution similarity (e.g., Kolmogorov-Smirnov (KS) distance, Earth mover's distance, Kullback-Leibler (KL) divergence) between the inference input(-output) data distribution (e.g., the inference distribution 310) and the different ML models input(-output) distributions (e.g., the training distributions 315). In such examples, the monitoring algorithm may select an ML model having a relatively high (e.g., a highest) input data distribution similarity with the inference data distribution. For example, a similarity between the training distribution 315-a and the inference distribution 310 may be relatively high. As such, the monitoring algorithm may select an ML model trained using training data corresponding to the training distribution 315-a. In some examples, the monitoring algorithm may set thresholds on the distribution similarity, for example, before falling back to non-ML operation. In some examples, AI/ML model monitoring based on the data distributions may provide a relatively simple, low-complexity approach for AI/ML model monitoring.

In the example of FIG. 3, the network node 305-b may be configured with (e.g., may deploy or may have trained) 3 ML models for beam prediction (e.g., temporal beam prediction). For example, the network node 305-b may have trained a first ML model using training data corresponding to the training distribution 315-a, a second ML model using training data corresponding to the training distribution 315-b, and a third ML model using training data corresponding to the training distribution 315-c. In other words, the training distribution 315-a may correspond to a first normalized input RSRP measurements distribution used in training AI/ML model #1, the training distribution 315-b may correspond to a second normalized input RSRP measurements distribution used in training AI/ML model #2, and the training distribution 315-c may correspond to a third normalized input RSRP measurements distribution used in training AI/ML model #3. That is, normalized input data distributions (RSRP measurement distributions f(x)) used in training three (different) models are illustrated as the training distribution 315-a, the training distribution 315-b, and the training distribution 315-c.

As illustrated in the example of FIG. 3, RSRP measurements used in training different AI/ML models have different distributions (e.g., because RSRP measurements come from different environments and operating conditions). For example, a mean RSRP measurements in indoor environments may be higher than a mean RSRP measurements in outdoor environments. During an inference phase, such as after the ML model 306 is deployed, the network node 305-b may measure (e.g., may start measuring) some RSRP measurements (e.g., input data to the AI/ML model). The RSRSP measurement distribution during inference (e.g., during the inference phase) is illustrated as the inference distribution 310.

The network node 305-b (or the network node 305-a) may compare the training distribution 315 (e.g., distribution of RSRPs used in training different AI/ML models) with the inference distribution 310 (e.g., RSRP measurements observed during inference) to determine which AI/ML model may be applicable to (e.g., better suited for) a current inference environment/operating conditions of the network node 305-b. The network node 305-b (or the network node 305-a) may use one or more approaches for comparing (e.g., calculating a distribution similarity between) the training distribution 315 and the inference distribution 310. The different approaches for calculating the distribution similarity may include calculating the KS distance between one or more of the training distributions 315 and the inference distribution 310 in accordance with the following Equation 1:

$$K S ( T , B ) = {sup}_{x ∈ ℝ} \vert {F}_{T} ( x ) - {F}_{B} ( x ) \vert . \qquad ( 1 )$$

or calculating the KL divergence between one or more of the training distributions 315 and the inference distribution 310 in accordance with the following Equation 2:

$$K L ( P ‖ Q ) = {\int }_{x} p ( x ) log \frac{q ( x )}{p ( x )} dx . \qquad ( 2 )$$

in which p and q correspond to the respective densities of P and Q. Additionally, or alternatively, an approach for calculating the distribution similarity may include calculating the Earth mover's distance between one or more of the training distributions 315 and the inference distribution 310.

In some examples, the network nodes 305 may support one or more beam management cases with a UE-side AI/ML model. In such examples, the network nodes 305 may support one or more one or more approaches for model monitoring with potential down-selection. For example, the network nodes 305 may support UE-side model monitoring in which a UE may monitor performance metrics and makes decisions regarding model selection, activation, deactivation, switching, and fallback operation. Additionally, or alternatively, the network nodes 305 may support network-side model monitoring in which the network may monitor the performance metrics and makes decisions regarding model selection, activation, deactivation, switching, and fallback operation. Additionally, or alternatively, the network nodes 305 may support hybrid model monitoring in which a UE monitors the performance metrics, and the network makes decisions regarding model selection, activation, deactivation, switching, and fallback operation.

Some ML models may work relatively well under an assumption that data observed during training and inference belong to a same feature space or distribution. The performance of an AI/ML model trained under an environment or operating conditions may be degraded as the environment or operating conditions change. Multiple factors may impact (e.g., affect) properties and distributions of inputs and outputs to an AI/ML model, such as the ML model 306. Such factors may include received power levels (e.g., signal-to-interference-plus-noise (SINR) levels) of an input reference signal used in training the model, a scheduling mode used by a serving node (e.g., whether a gNB may be using SU- or MU-MIMO), a reference signal type (e.g., used for measurements or prediction), a change in operating characteristics (e.g., a change in bandwidth, band, or beams), an energy per resource element (EPRE), a quantity of ports, a quantity of panels, a quantity of antenna elements, a variation in the environment (e.g., whether the network node 305-b may be operating in a rural or urban environment, whether the environment is associated with high Doppler or low Doppler, whether the environment is associated with high interference or low-interference).

In some examples, such as examples in which data drift occurs, the ML model 306 used at the network node 305-b (e.g., an underlying ML model) may be re-trained using different (e.g., new) training data consistent with the different (e.g., new) environment or operating conditions. However, collecting training data and re-training the ML model 306 may be a time-consuming (e.g., relatively high-latency) and a relatively high-overhead operation.

In some other examples, the network nodes 305 may support a framework for re-training ML models using importance weights. That is, the network nodes 305 may use importance weights or, more simply, weights, to re-train (e.g., finetune) ML models. For example, an error in predictions caused due to data shift may be removed by using importance weight, which may be determined in accordance with the following Equation 3:

$$W ( {X}_{i} ) = \frac{{P}_{test} ( {X}_{i} )}{{P}_{train} ( {X}_{i} )} \qquad ( 3 )$$

in which Xᵢ correspond to input training data (e.g., a datum or data of a training data set) for a training instance i. As an illustrative example, for ML models used for beam predictions, Xᵢ may correspond to one or more RSRP measurements. Similarly, for ML models used for interference predictions, Xᵢ may correspond to one or more interference power measurements. Additionally, Pₜₑₛₜ(Xᵢ) and Pₜₑₛₜ(Xᵢ) correspond to the probabilities of finding an input Xᵢ in a test data set (e.g., inference data set) and a training data set, respectively. As such, a value of an importance weight W(Xᵢ) for an input Xᵢ may be relatively high (e.g., during training) if a training instance (e.g., the input Xᵢ) is highly likely to occur in the test data set (e.g., in the inference data set). In some examples, W(Xᵢ) may define the importance values for the training data (e.g., all training data) which may be weighted during a loss function calculation.

In some examples, however, values of importance weights may not be known apriori and, as such, may be estimated during deployment. The network nodes 305 may support one or more approaches for calculating the importance weights W(Xᵢ). For example, the network nodes 305 may support a kernel density estimation (KDE) approach, a discriminative learning approach, and a kernel mean matching approach, among other examples.

In some examples, the network nodes 305 may support, to identify an event, monitoring a metric associated with a performance of the ML model, and determining that the metric satisfies a threshold, where calculating the set of weights is based on the metric satisfying the threshold. For example, the network nodes 305 may support calculating the importance weights and subsequently finetune the ML model based on thresholds associated with ML model monitoring. In some examples, if performance of the current ML model is below a specific threshold (e.g., Top-K interference (or beam) prediction accuracy is below 90%), the network nodes 305 may be triggered to calculate the importance weights and finetune the ML model.

In some examples, the network nodes 305 may support outputting control signaling including a configuration to calculate the set of weights, the configuration indicative of a set of parameters for calculating the set of weights. Calculating the set of weights may be performed in accordance with the set of parameters and based on operating conditions for maintaining the wireless communication link. For example, the network nodes 305 may support a configuration of importance weight calculation parameters at a network node based on knowledge of environment conditions.

In some examples, the network nodes 305 may support outputting, in response to statistics corresponding to the set of weights exceeding a threshold, control signaling including a configuration to switch from calculating the set of weights associated with the ML model to calculating the set of weights based on a second ML model or new data, or switching from calculating the set of weights associated with the ML model to calculating the set of weights without using a ML model. For example, the network nodes 305 may support a network node being configured to fallback to a non-AI/ML operation, or to switch an ML model or train with new data if the importance weight statistics (e.g., mean, variance or variation in importance weights) exceeds a configured threshold.

In some examples, the network nodes 305 may support, identifying a variation in statistics corresponding to the set of weights, or outputting control signaling including a configuration to calculate the set of weights without a request to collect new data for calculating the set of weights. For example, the network nodes 305 may support a network node observing variations in the measurement statistics. The observing network node may calculate importance weights and finetune the ML model without collecting new data.

In some examples, the network nodes 305 may support, obtaining a report indicative of a recommendation to recalculate the set of weights, and outputting the information indicative of the recalculated set of weights based on the recommendation. For example the network nodes 305 may support a network node observing variations in measurements. Accordingly, the network node may report recommendations indicating to recalculate the importance weights to finetune ML models.

The KDE approach may include a non-parametric method to obtain an approximation of the probability density function of a random variable. In accordance with the KDS approach, the network nodes 305 may determine Pₜᵣₐᵢₙ(Xᵢ) in accordance with the following Equation 4:

$${\hat{P}}_{train} ( x ) = \frac{1}{{n ( 2 π {σ}^{2} )}^{\frac{d}{2}}} {\sum }_{i = 1}^{{n}_{train}} {K}_{σ} ( x - {x}_{i} ) \qquad ( 4 )$$

and the network nodes 305 may determine Pₜₑₛₜ (Xᵢ) in accordance with the following Equation 5:

$${\hat{P}}_{test} ( x ) = \frac{1}{{n ( 2 π {σ}^{2} )}^{\frac{d}{2}}} {\sum }_{i = 1}^{{n}_{t e s t}} {K}_{σ} ( x - {x}_{i} ) \qquad ( 5 )$$

in which K_{σ}(x−xᵢ) corresponds to a Gaussian kernel, which may be determined in accordance with the following Equation 6:

$$K ( x , {x}^{′} ) = exp ( \frac{- ‖ x - {x}^{′} ‖}{2 {σ}^{2}} ) \qquad ( 6 )$$

in which x and x′ correspond to two kernel samples, a corresponds to a kernel width, and a value (e.g., a best possible value, an optimized value) of a may be obtained by cross validation.

Importance weights may be used to weight a loss of each training instance (e.g., a difference between a datum used for training and a corresponding datum used for inference) differently. For example, a training instance may be more likely to appear during inference and, as such, the training instance may have higher weight in the loss function calculation. A higher weight may correspond to (e.g., is equivalent to) a higher penalty for wrongly predicting the training instance, which may be reflected in higher gradient values in the backpropagation. Higher gradient values may lead to more tuning of the ML model parameters. In some other examples, a training instance may be less likely to appear during inference (e.g., due to drift in the environment) and, as such, the training instance may have a lower weight in the loss function calculation. A lower weight may have a lower effect on the ML model parameters (e.g., even if the ML model output a wrong prediction for the corresponding training instance during re-training). The loss function may include an MSE function. For example, the loss for an interference prediction may include the MSE between the predicted interference (or SINR) and the ground truth interference (or SINR). Similarly, the loss for a beam prediction may include an MSE between the predicted RSRP and the ground truth RSRP.

Without importance weights, the MSE (J) may be determined in accordance with the following Equation 7:

$$J = \frac{1}{n} {\sum }_{i = 0}^{n} {( {h}_{θ} ( {X}_{i} ) - {y}_{i} )}^{2} \qquad ( 7 )$$

in which h_{θ}(Xᵢ) corresponds to a predicted value (e.g., interference, RSRP) at instance i, using ML model, h_{θ}. Additionally, yᵢ corresponds to the ground truth value (e.g., interference, RSRP) at instance i and n corresponds to a quantity of training instances. In some examples, multiple (e.g., all) training instance may have equal (or about equal) weights in the loss function calculation. With importance weights, the MSE (J) may be determined in accordance with the following Equation 8:

$$J = \frac{1}{n} {\sum }_{i = 0}^{n} W ( {X}_{i} ) {( {h}_{θ} ( {X}_{i} ) - {y}_{i} )}^{2} . \qquad ( 8 )$$

Training instances may be weighted depending on how likely data with similar statistical properties may appear in an environment.

As illustrated in the example of FIG. 3, the network node 305-a (e.g., a gNB, an LMF, a RIC, a UE) may calculate a set of weights for a set of training data. The set of training data may be used to training the ML model 306 in accordance with the first operating conditions for maintaining the communication link 330 (e.g., at the location 320-a). That is, the set of training data may have the training distribution 315-a. Each weight (W(Xᵢ)) of the set of weights may be associated with a respective datum (Xᵢ) of the set of training data (e.g., the training data with a training distribution 315-a). Additionally, each weight of the set of weights may be based on a probability that the respective datum is included in a set of inference data. That is, a training instance (Xᵢ) may have a relatively high weight if the training instance has a relatively high likelihood of occurring in the set of inference data. The set of inference data may be associated with obtaining predictions using the ML model 306 in accordance with the second operating conditions for maintaining the communication link 330 (e.g., for making predictions using the ML model 306 at the location 320-b). For example, the network node 305-b may move from the location 320-a to the location 320-b and the set of inference data may have statistical properties of the environment or operating conditions associated with the location 320-b.

In some examples, the network node 305-a (or the network node 305-b) may identify an event associated with the ML model 306. For example, the network node 305-a (or the network node 305-b) may detect data drift, a handover being triggered, the network node 305-a (or the network node 305-b) may determine that a data drift or reduction in performance of the ML model 306 satisfies a threshold (e.g., based on ML monitoring), or the network node 305-b may request the set of importance weights from the network node 305-a, among other types of events. In such examples, the network node 305-a may output an ML model weights indication 335 to the network node 305-b (e.g., another gNB, another LMF, another RIC, another UE) based on the event (e.g., in response to identifying the event). The ML model weights indication 335 may include information indicative of the set of weights (e.g., importance weights information). In some examples, the network node 305-b may modify the ML model 306 based on the information (e.g., based on the ML model weights indication 335). In such an example, the network node 305-b may obtain a prediction pertaining to the communication link 330 using the modified ML model 306. In some examples,

Use of importance weights may enable the network nodes 305 (e.g., the UE, the network) to re-use the same training data but weight the training set differently during the ML model re-training (e.g., finetuning) operation such that the ML model is suitable for a different (e.g., new) environment. In other words, by using importance weights for re-training the ML model 306, the network nodes 305 may refrain from collecting new training data (e.g., no new data is collected), which may lead to increased performance and reduced overhead, among other benefits.

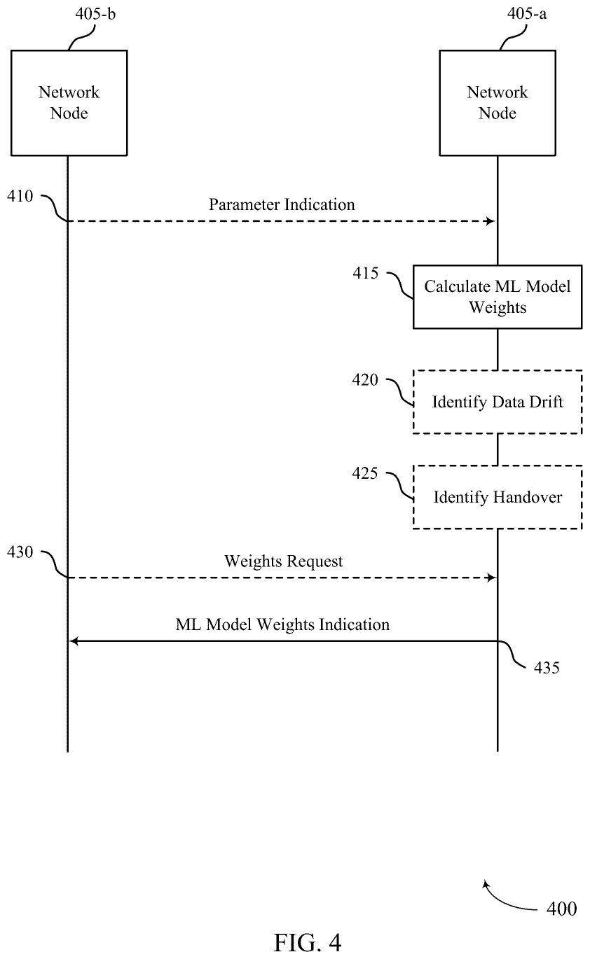

FIG. 4 shows an example of a process flow 400 that supports techniques for modifying ML models using importance weights in accordance with one or more aspects of the present disclosure. The process flow 400 may implement or may be implemented by aspects of the wireless communications system 100, the network architecture 200, and the wireless communications system 300. For example, the process flow 400 illustrates operations at a network node 405-a and a network node 405-b, which may be examples of a UE or network entity (e.g., a CU, a DU, an RU, a base station, an IAB node, or one or more other network nodes) illustrated by and described with reference to FIGS. 1 through 3. For example, the network nodes 405 may each be an example of a gNB, an LMF, a RIC, or a UE (e.g., a hub UE, an anchor UE, a coordinator UE). The operations performed at the network nodes 405 may support improvements to communications between the network nodes 405, among other benefits. In the following description of the process flow 400, the operations performed at the network nodes 405 may occur in a different order than the example order shown. Additionally, the operations performed at the network nodes 405 may be performed at different times. Some operations may be combined, and some operations may be omitted. In some examples, the network nodes 405 may support a framework for communicating importance weights between network nodes.

At 415, the network node 405-a may calculate a set of ML model weights for a set of training data. The set of training data may be used to training an ML model used at the network node 405-b in accordance with first operating conditions for maintaining a communication link. The communication link may be an example of a communication link illustrated by and described with reference to FIGS. 1 through 3. For example, the communication link may be an example of a Uu link (e.g., a downlink, an uplink), a sidelink, a fronthaul link, a midhaul link, or a backhaul link, among other examples of communication links. The set of weights may be an example of a set of weights illustrated by and described with reference to FIG. 3. For example, each weight (W(Xᵢ)) of the set of weights may be associated with a respective datum (Xᵢ) of the set of training data and each weight of the set of weights may be based on a probability that the respective datum is included in a set of inference data. The set of inference data may be associated with obtaining predictions using the ML model in accordance with second operating conditions for maintaining the communication link.

In some examples, at 410, the network node 405-a may receive a parameter indication from the network node 405-b. That is, the network node 405-a may output control signaling including a configuration to calculate the set of weights, the configuration indicative of a set of parameters for calculating the set of weights at 415 in accordance with the set of parameters and based on operating conditions for maintaining the wireless communication link. For example, the network node 405-b may configure weights calculation parameters (e.g., importance weights calculation parameters) at the network node 405-a. In such an example, the network node 405-b may also configure a scheme for calculating the set of weights. That is, the network node 405-b may configure the network node 405-a with an importance weights calculation approach, such as KDE, discriminative learning, or kernel mean matching, and may also configure the parameters of importance weights estimation in the configured approach. For example, the network node 405-b may configure the kernal width (σ) in the KDE importance weights calculation method. In such an example, the network node 405-a may calculate the set of weights is in accordance with the set of parameters (e.g., and the configured approach).

In some examples, the network node 405-a may monitor a metric associated with a performance of the ML model, and determine that the metric satisfies a threshold, where calculating the set of weights is based on the metric satisfying the threshold.

In some examples, the network node 405-b may output, in response to statistics corresponding to the set of weights exceeding a threshold, control signaling including a configuration to switch from calculating the set of weights associated with the ML model to calculating the set of weights based on a second ML model or new data, or switch from calculating the set of weights associated with the ML model to calculating the set of weights without using an ML model.

In some examples, the network node 405-b may identify a variation in statistics corresponding to the set of weights, and output control signaling including a configuration to calculate the set of weights without a request to collect new data for calculating the set of weights.

In some examples, the network node 405-b may obtain a report indicative of a recommendation to recalculate the set of weights, and output the information indicative of the recalculated set of weights based on the recommendation.

At 435, the network node 405-a may transmit (e.g., output) an ML model weights indication to the network node 405-b. The ML model weights indication may be an example of an ML model weights indication illustrated by and described with reference to FIG. 3. For example, the ML model weights indication may include importance weights information and the network node 405-a may transmit the ML model weights indication based on identifying an event associated with the ML model. The ML model may be used at the network node 405-b for obtaining the predictions using the ML model.

For example, at 420, the network node 405-a may identify data drift associated with the ML model. The data drift may be an example of data drift illustrated by and described with reference to FIG. 3. For example, the data drift may correspond to a difference between the set of training data and the set of inference data. In such an example, the network node 405-a may calculate the set of weights (at 415) based on identifying the data drift. Additionally, the network node 405-a may share information indicative of the set of weights (e.g., importance weights information) with the network node 405-b to aid the network node 405-b with modifying (e.g., re-training, finetuning) the ML model (e.g., and one or more other ML models). That is, the network node 405-a may detect data drift (e.g., a change in the applicability of the ML model to the environment), calculate the set of weights, and shares the importance weights information with the network node 405-b (e.g., and one or more other UEs) to help with ML model re-training (e.g., without collecting new data). The importance weights information (e.g., indicated via the ML model weights indication transmitted at 435) may include information for weights for the set of training data (e.g., the entire set of training data, all training data), or importance weights information for a portion of the set of training data (e.g., to aid the network node 405-b with re-training the ML model using a relatively small portion of the set of training data). That is, the information indicative of the set of weights may include first information indicative of each weight of the set of weights or may include second information indicative of a portion of the set of weights, in which the portion of the set of weights may be associated with a respective portion of the set of training data. In some examples, including weights information for a portion of the set of training data may reduce overhead, among other benefits. In some other examples, the network node 405-a may share importance weights statistics to aid the network node 405-b in understanding a change in the environment of the network node 405-b. That is, the information indicative of the set of weights may include information indicative of statistics corresponding to the set of weights (or a portion of the set of weights). The importance weights statistics may include an importance weights distribution, a mean, a median, a variance, one or more higher order moments, or a function of the importance weights distribution.

In some other examples, at 425, the network node 405-a may identify a handover of the network node 405-b from a first cell to a second cell. In such an example the handover of the network node 405-b may trigger importance weights sharing, for example, to aid the network node 405-b with modifying (e.g., re-training, finetuning) the ML model. In such an example, the network node 405-a may share the importance weights information during the handover (e.g., within a duration associated with the handover). For example, the network node 405-b may be configured with site-specific or cell-specific ML models and, as such, may perform a model transfer in response to a change in an environment of the network node 405-b. In some examples, a model transfer may introduce performance gains. However, site-specific ML models may constrain the network node 405-a to share the ML model with the network node 405-b after training the ML model at the network node 405-a, which may lead to increased overhead (e.g., as ML models may include millions of parameters). To reduce overhead, the network node 405-a may indicate the importance weights on the set of training data (e.g., on a portion of the set of training data) to the network node 405-b during handover to aid the network node 405-b with modifying the ML model (e.g., without sharing the ML model parameters).

The network node 405-a may report the importance weights information to the network node 405-b to aid the network node 405-b in understanding the environment. For example, the network node 405-a may detect data drift (e.g., at 420) and calculating the importance weights (e.g., at 415). In such an example, the network node 405-a may report the importance weights information to aid the network node 405-b in understanding an amount of drift detected in the environment, which may aid the network node 405-b with modifying the ML model (e.g., for two-sided ML models). In some examples, sharing the importance weights information may enable the network node 405-b to share the importance weight information with other network nodes to aid the other network nodes in modifying other ML models. For example, the other network nodes may be associated with the second operating conditions (e.g., same operating conditions as the network node 405-b). In some examples, the network node 405-a may report the importance eights information based on one or more statistical properties of the importance weights satisfying a condition. For example, a variance of the importance weights may satisfy (e.g., exceeds) a threshold, which may trigger the network node 405-a to reports the importance weights information to the network node 405-b.

In some examples, the network node 405-a may share importance weights information based on ML model monitoring. For example, the network node 405-a may monitor a metric associated with a performance of the ML model and determine that the metric satisfies a threshold. In such an example, the network node 405-a may calculate the set of weights based on the metric satisfying the threshold. In some examples, the network node 405-a (e.g., and the network node 405-b) may use multiple (e.g., different) ML model monitoring approaches, such as monitoring based on inference accuracy (e.g., interference or beam prediction accuracy), monitoring based on system performance (e.g., throughput. UPT), or monitoring based on data distribution (e.g., drift between training and inference, such as for interference, SINR, or RSRP measurements). That is, the metric may include a prediction accuracy metric, a system performance metric, or a data distribution metric. In some examples, the network node 405-a may be configured to report the importance weights information to the network node 405-b based on thresholds associated with the ML model monitoring. For example, the network node 405-b may utilize an ML model for interference or beam prediction and may monitor the ML model using performance-based monitoring. In such an example, if the performance of the ML model fails to satisfy (e.g., is below) a threshold (e.g., a top-k interference or beam prediction accuracy is below 90%), the network node 405-a may be triggered to calculate the importance weights (e.g., based on the new environment) and report the importance weights to the network node 405-b. In some examples, such reporting may improve a performance of two-sided ML models.

In some examples, at 430, the network node 405-a may receive a weights request from the network node 405-b. That is, the network node 405-b may request importance weights information from the network node 405-a. For example, after the network node 405-b detects a drift in the data distribution or notices a degradation in a performance of the ML model, the network node 405-b may request for the network node 405-a to share the importance weights to aid the network node 405-b with modifying the ML model. In some examples, the network nodes 405 may both be UEs. In such an example, the importance weights information may be shared between the UEs though UE-to-UE communication, which may be on-demand (e.g., in response to a request, such as the weights request at 430) or after the network node 405-a (e.g., the signaling UE) detects data drift and calculates the importance weights.

In some examples, the network node 405-a may monitor a metric associated with a performance of the ML model, and the network node 405-a may determine that the metric satisfies a threshold, where calculating the set of weights is based on the metric satisfying the threshold.

In some examples, the network node 405-b may output control signaling including a configuration to calculate the set of weights, the configuration indicative of a set of parameters for calculating the set of weights, where calculating the set of weights is in accordance with the set of parameters and based on operating conditions for maintaining the wireless communication link.

In some examples, the network node 405-b may output, in response to statistics corresponding to the set of weights exceeding a threshold, control signaling including a configuration to switch from calculating the set of weights associated with the ML model to calculating the set of weights based on a second ML model or new data, or switch from calculating the set of weights associated with the ML model to calculating the set of weights without using a ML model. The network node 405-b may identify a variation in statistics corresponding to the set of weights, and output control signaling including a configuration to calculate the set of weights without a request to collect new data for calculating the set of weights.

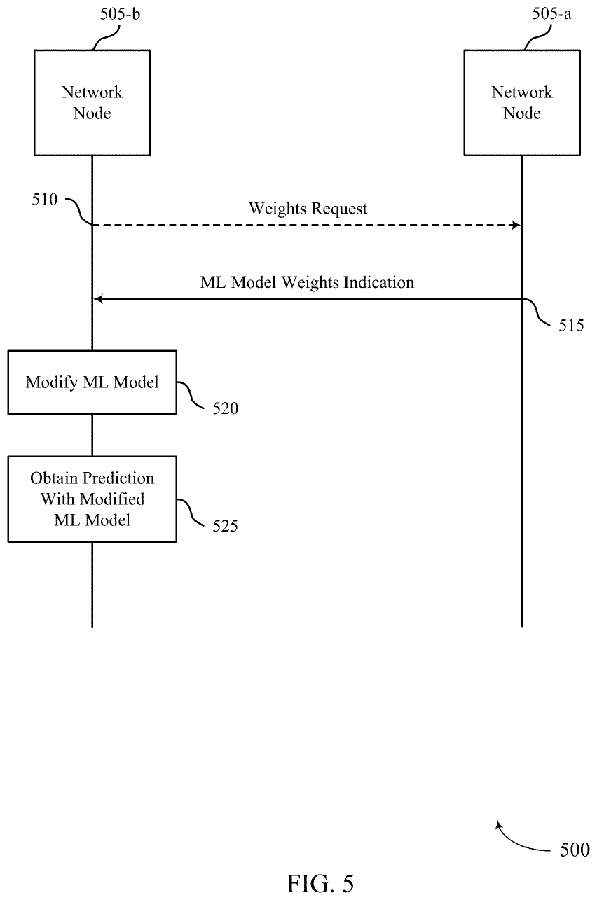

FIG. 5 shows an example of a process flow 500 that supports techniques for modifying ML models using importance weights in accordance with one or more aspects of the present disclosure. The process flow 500 may implement or may be implemented by aspects of the wireless communications system 100, the network architecture 200, the wireless communications system 300, and the process flow 400. For example, the process flow 500 illustrates operations at a network node 505-a and a network node 505-b, which may be examples of a UE or network entity (e.g., a CU, a DU, an RU, a base station, an IAB node, or one or more other network nodes) illustrated by and described with reference to FIGS. 1 through 4. For example, the network nodes 505 may each be an example of a gNB, an LMF, a RIC, or a UE (e.g., a hub UE, an anchor UE, a coordinator UE). The operations performed at the network nodes 505 may support improvements to communications between the network nodes 505, among other benefits. In the following description of the process flow 500, the operations performed at the network nodes 505 may occur in a different order than the example order shown. Additionally, the operations performed at the network nodes 505 may be performed at different times. Some operations may be combined, and some operations may be omitted. In some examples, the network nodes 505 may support a framework for communicating importance weights between network nodes.

At 515, the network node 505-b may receive (e.g., obtain) an ML model weights indication from the network node 405-a. The ML model weights indication may be an example of an ML model weights indication illustrated by and described with reference to FIGS. 3 and 4. For example, the ML model weights indication may include importance weights information indicative of a set of ML model weights for a set of training data. The set of training data may be used to training an ML model used at the network node 505-b in accordance with first operating conditions for maintaining a communication link. The communication link may be an example of a communication link illustrated by and described with reference to FIGS. 1-4. For example, the communication link may be an example of a Uu link (e.g., a downlink, an uplink), a sidelink, a fronthaul link, a midhaul link, or a backhaul link, among other examples of communication links. The set of weights may be an example of a set of weights illustrated by and described with reference to FIG. 3. For example, each weight of the set of weights may be associated with a respective datum (Xi) of the set of training data and each weight of the set of weights may be based on a probability that the respective datum is included in a set of inference data. The set of inference data may be associated with obtaining predictions using the ML model in accordance with second operating conditions for maintaining the communication link. In some examples, the network node 405-a may obtain the importance weights information based on ML model monitoring.

For example, at 510, the network node 505-b may transmit a weights request to the network node 505-a. That is, the network node 505-b may request importance weights information from the network node 505-a. For example, the network node 505-b may detect a drift in a data distribution of the set of training data or may notice a degradation in a performance of the ML model. In such an example, the network node 505-b may request for the network node 505-a to share the importance weights to aid the network node 505-b with modifying the ML model.

In some examples, the network node 505-b may perform multiple (e.g., different) actions based on the importance weights information (e.g., based on importance weights statistics). For example, the importance weights information (e.g., and the importance weights) may help in re-training the ML-model without necessitating the collect additional (e.g., new) data, and may provide a relatively good measure on how much data drift has occurred in the environment of the network node 505-b.

At 520, the network node 505-b may modify the ML model based on the importance weights information. For example, the network node 505-b may re-train (e.g., refine, retune) the ML model using the importance weights information.

At 525, the network node 505-b may obtain a prediction pertaining to the communication link using the modified ML. In some examples, the network node 505-b may output the receive importance weights information to other network nodes that may be associated with the second operating conditions (e.g., same operating conditions as the network node 505-b).

In some examples, the network node 505-b can be configured to transition to (e.g., fallback to) non-AI/ML operation or switch the ML model or train with another set of training data, for example, if the importance weight information (e.g., importance weights statistics, such as mean and variance) satisfies a threshold (e.g., exceeds a configured or predefined threshold). For example, the network node 505-b may determine that a statistical property associated with the set of weights satisfies a condition and, in response, may refrain from using the ML for other predictions (e.g., may refrain from obtaining another prediction pertaining to the communication link using the ML model). Additionally, or alternatively, the network node 505-b may switch the ML model from a first ML model associated with the first operating conditions to a second ML model associated with the second operating conditions. In some examples, in response to determining that the statistical property satisfies the condition, the network node 505-b may train the ML model using another set of training data that is associated with the second operating conditions.

In some examples, the network node 505-b may perform multiple (e.g., different) actions based on overhead associated with reporting importance weights. For example, the overhead associated with reporting the importance weights may be relatively large (e.g., due to a relatively large deviation or drift in the operating conditions of the environment relative to the operating conditions associated with the set of training data). In such an example, the network node 505-b may be configured to train the ML model with another set of training data (e.g., with new data). In some other examples, the overhead associated with reporting the importance weights may be low (e.g., importance weights for a subset of the set of training data may be reported). In such an example, the importance weights may be used to re-train the ML model.

In some examples, the importance weights information (e.g., or the ML models, or the actions to be performed at the network node 505-b based on the importance weights information) may be configured at the network node 505-b via control signaling. For example, the network node 505-a may configure the network node 505-b with the importance weights information statically (e.g., through RRC signaling). Additionally, or alternatively, the importance weights information may be activated or deactivated semi-statically (e.g., through a MAC-CE) or dynamically (e.g., through DCI). The importance weights information may be shared on an uplink channel resource (e.g., a physical uplink shared channel (PUSCH) resource for uplink), on a downlink channel resource (e.g., a physical downlink shared channel (PDSCH) resource for downlink), or a sidelink channel resource (e.g., a physical sidelink shared channel (PSSCH) resource for sidelink). In other words, the network node 505-a (e.g., the network node sharing the importance weights information) and the network node 505-b (e.g., the network node receiving the importance weights information) may each be one or more types of server nodes (e.g., any server node, such as gNB, an LMF, a RIC, a hub UE, an anchor UE, or a coordinator UE node in case of sidelink).

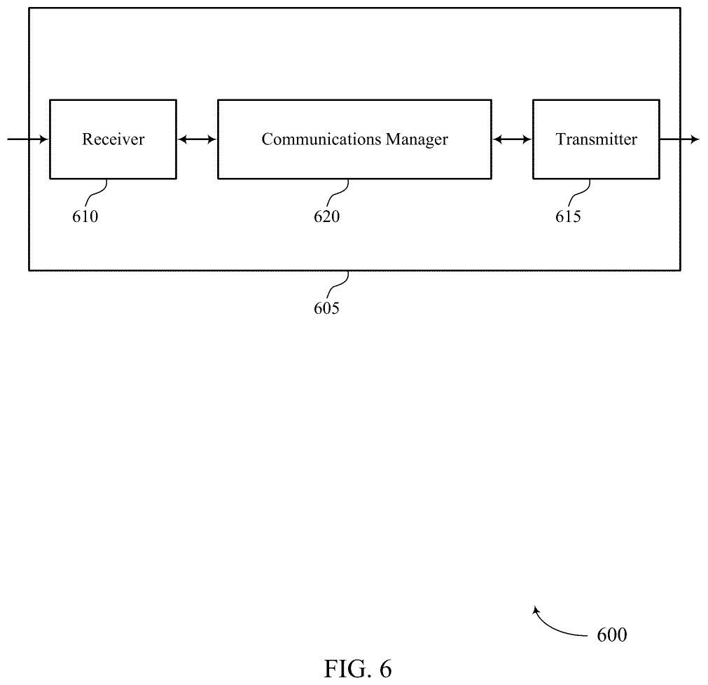

FIG. 6 shows a block diagram 600 of a device 605 that supports techniques for modifying ML models using importance weights in accordance with one or more aspects of the present disclosure. The device 605 may be an example of aspects of a UE 115 or a network entity 105 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for modifying ML models using importance weights). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for modifying ML models using importance weights). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for modifying ML models using importance weights as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), a graphics processing unit (GPU), a neural processing unit (NPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in hardware, code (e.g., as communications management software) executed by a processor, or any combination thereof. If implemented in code executed by at least one processor, the functions of the communications manager 620, the receiver 610, the transmitter 615, or various combinations or components thereof may be performed by a general-purpose processor, a DSP, a CPU, a GPU, an NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. For example, the communications manager 620 is capable of, configured to, or operable to support a means for calculating a set of weights for a first set of data associated with training an ML model in accordance with a first set of operating conditions for maintaining a wireless communication link, where each weight of the set of weights is associated with a respective datum of the first set of data, and where each weight of the set of weights is based on a probability that the respective datum is included in a second set of data, the second set of data being associated with obtaining predictions using the ML model in accordance with a second set of operating conditions for maintaining the wireless communication link. The communications manager 620 is capable of, configured to, or operable to support a means for identifying an event associated with the ML model. The communications manager 620 is capable of, configured to, or operable to support a means for outputting information indicative of the set of weights based on identifying the event.

Additionally, or alternatively, the communications manager 620 may support wireless communication in accordance with examples as disclosed herein. For example, the communications manager 620 is capable of, configured to, or operable to support a means for obtaining information indicative of a set of weights for a first set of data associated with training an ML model in accordance with a first set of operating conditions for maintaining a wireless communication link, where each weight of the set of weights is associated with a respective datum of the first set of data, and where each weight of the set of weights is based on a probability that the respective datum is included in a second set of data, the second set of data being associated with obtaining predictions using the ML model in accordance with a second set of operating conditions for maintaining the wireless communication link. The communications manager 620 is capable of, configured to, or operable to support a means for modifying the ML model based on the information. The communications manager 620 is capable of, configured to, or operable to support a means for obtaining a prediction pertaining to the wireless communication link using the modified ML model.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing and more efficient utilization of communication resources.

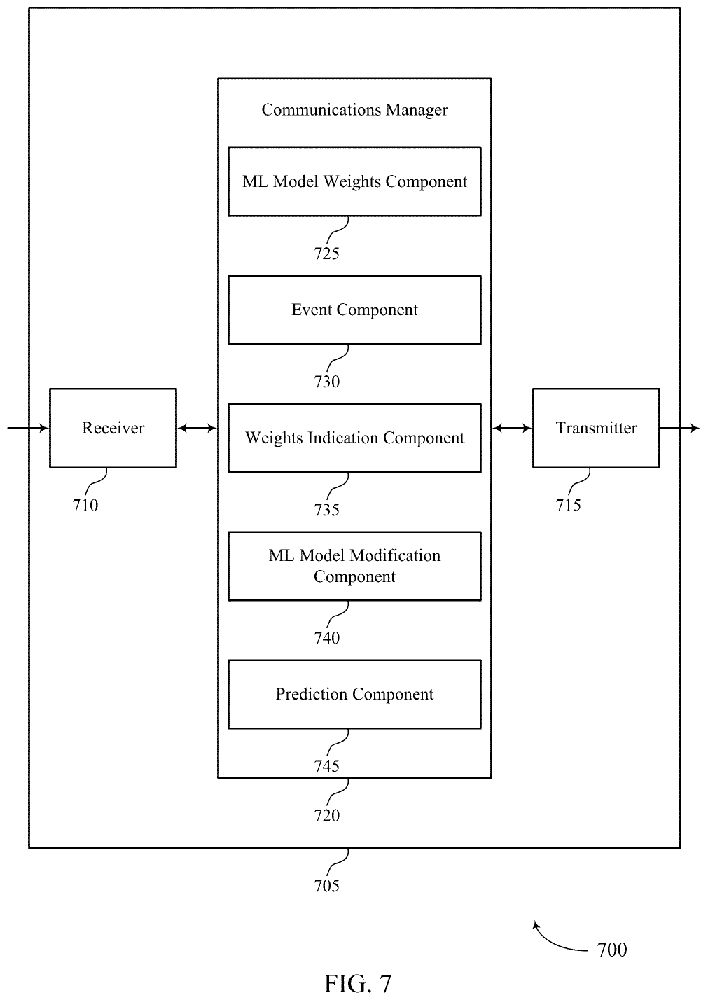

FIG. 7 shows a block diagram 700 of a device 705 that supports techniques for modifying ML models using importance weights in accordance with one or more aspects of the present disclosure. The device 705 may be an example of aspects of a device 605, a UE 115, or a network entity 105 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for modifying ML models using importance weights). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for modifying ML models using importance weights). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for modifying ML models using importance weights as described herein. For example, the communications manager 720 may include an ML model weights component 725, an event component 730, a weights indication component 735, an ML model modification component 740, a prediction component 745, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. The ML model weights component 725 is capable of, configured to, or operable to support a means for calculating a set of weights for a first set of data associated with training an ML model in accordance with a first set of operating conditions for maintaining a wireless communication link, where each weight of the set of weights is associated with a respective datum of the first set of data, and where each weight of the set of weights is based on a probability that the respective datum is included in a second set of data, the second set of data being associated with obtaining predictions using the ML model in accordance with a second set of operating conditions for maintaining the wireless communication link. The event component 730 is capable of, configured to, or operable to support a means for identifying an event associated with the ML model. The weights indication component 735 is capable of, configured to, or operable to support a means for outputting information indicative of the set of weights based on identifying the event.

Additionally, or alternatively, the communications manager 720 may support wireless communication in accordance with examples as disclosed herein. The ML model weights component 725 is capable of, configured to, or operable to support a means for obtaining information indicative of a set of weights for a first set of data associated with training an ML model in accordance with a first set of operating conditions for maintaining a wireless communication link, where each weight of the set of weights is associated with a respective datum of the first set of data, and where each weight of the set of weights is based on a probability that the respective datum is included in a second set of data, the second set of data being associated with obtaining predictions using the ML model in accordance with a second set of operating conditions for maintaining the wireless communication link. The ML model modification component 740 is capable of, configured to, or operable to support a means for modifying the ML model based on the information. The prediction component 745 is capable of, configured to, or operable to support a means for obtaining a prediction pertaining to the wireless communication link using the modified ML model.

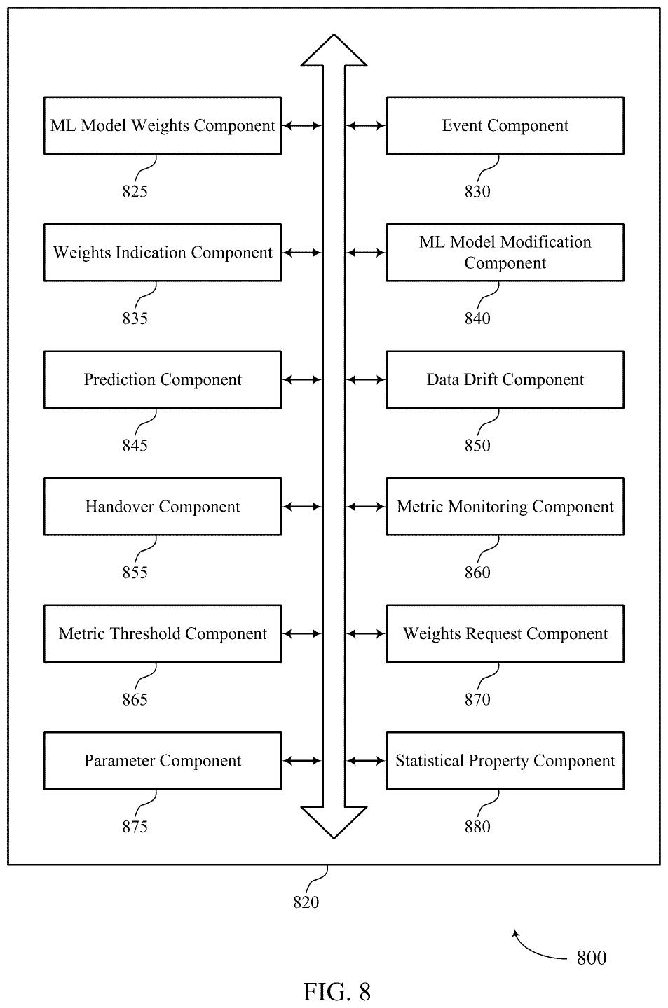

FIG. 8 shows a block diagram 800 of a communications manager 820 that supports techniques for modifying ML models using importance weights in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for modifying ML models using importance weights as described herein. For example, the communications manager 820 may include an ML model weights component 825, an event component 830, a weights indication component 835, an ML model modification component 840, a prediction component 845, a data drift component 850, a handover component 855, a metric monitoring component 860, a metric threshold component 865, a weights request component 870, a parameter component 875, a statistical property component 880, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 820 may support wireless communication in accordance with examples as disclosed herein. The ML model weights component 825 is capable of, configured to, or operable to support a means for calculating a set of weights for a first set of data associated with training an ML model in accordance with a first set of operating conditions for maintaining a wireless communication link, where each weight of the set of weights is associated with a respective datum of the first set of data, and where each weight of the set of weights is based on a probability that the respective datum is included in a second set of data, the second set of data being associated with obtaining predictions using the ML model in accordance with a second set of operating conditions for maintaining the wireless communication link. The event component 830 is capable of, configured to, or operable to support a means for identifying an event associated with the ML model. The weights indication component 835 is capable of, configured to, or operable to support a means for outputting information indicative of the set of weights based on identifying the event.

In some examples, to support identifying the event, the data drift component 850 is capable of, configured to, or operable to support a means for identifying data drift associated with the ML model, where the data drift corresponds to a difference between the first set of data and the second set of data, and where calculating the set of weights is based on identifying the data drift.

In some examples, to support outputting the information, the weights indication component 835 is capable of, configured to, or operable to support a means for outputting the information to a UE, where the ML model is used at the UE for obtaining the predictions using the ML model.

In some examples, the information indicative of the set of weights includes first information indicative of each weight of the set of weights or includes second information indicative of a portion of the set of weights, the portion of the set of weights being associated with a respective portion of the first set of data.

In some examples, the information indicative of the set of weights includes first information indicative of statistics corresponding to the set of weights. In some examples, the network node includes a UE. In some examples, the ML model is used at the UE for obtaining the predictions using the ML model.

In some examples, to support outputting the information, the statistical property component 880 is capable of, configured to, or operable to support a means for outputting the information based on a statistical property associated with the set of weights satisfying a condition.

In some examples, to support outputting the information, the weights indication component 835 is capable of, configured to, or operable to support a means for outputting the information to a second UE associated with the second set of operating conditions.

In some examples, to support identifying the event, the handover component 855 is capable of, configured to, or operable to support a means for identifying a handover of a UE from a first cell to a second cell, where the information is output to the UE within a duration associated with the handover.

In some examples, to support identifying the event, the metric monitoring component 860 is capable of, configured to, or operable to support a means for monitoring a metric associated with a performance of the ML model. In some examples, to support identifying the event, the metric threshold component 865 is capable of, configured to, or operable to support a means for determining that the metric satisfies a threshold, where calculating the set of weights is based on the metric satisfying the threshold.

In some examples, the metric includes a prediction accuracy metric, a system performance metric, or a data distribution metric. In some examples, to support identifying the event, the weights request component 870 is capable of, configured to, or operable to support a means for obtaining a request for weights associated with training the ML model, where outputting the information is in response to obtaining the request.

In some examples, the parameter component 875 is capable of, configured to, or operable to support a means for outputting control signaling including a configuration to calculate the set of weights, the configuration indicative of a set of parameters for calculating the set of weights, where calculating the set of weights is in accordance with the set of parameters and based on operating conditions for maintaining the wireless communication link. In some examples, the set of parameters are based on a scheme used for the weight calculations. In some examples, the scheme includes a KDE, a discriminative learning, or a kernel mean matching. Additionally, or alternatively, the communications manager 820 may support wireless communication in accordance with examples as disclosed herein.

In some examples, the ML model weights component 825 is capable of, configured to, or operable to support a means for outputting, in response to statistics corresponding to the set of weights exceeding a threshold, control signaling comprising a configuration to switch from calculating the set of weights associated with the ML model to calculating the set of weights based on a second ML model or new data, or switch from calculating the set of weights associated with the ML model to calculating the set of weights without using a ML model.

In some examples, the ML model weights component 825 is capable of, configured to, or operable to support a means for identifying a variation in statistics corresponding to the set of weights, and outputting control signaling including a configuration to calculate the set of weights without a request to collect new data for calculating the set of weights.

In some examples, the ML model weights component 825 is capable of, configured to, or operable to support a means for obtaining a report indicative of a recommendation to recalculate the set of weights, and outputting the information indicative of the recalculated set of weights based on the recommendation.

In some examples, the ML model weights component 825 is capable of, configured to, or operable to support a means for obtaining information indicative of a set of weights for a first set of data associated with training an ML model in accordance with a first set of operating conditions for maintaining a wireless communication link, where each weight of the set of weights is associated with a respective datum of the first set of data, and where each weight of the set of weights is based on a probability that the respective datum is included in a second set of data, the second set of data being associated with obtaining predictions using the ML model in accordance with a second set of operating conditions for maintaining the wireless communication link. The ML model modification component 840 is capable of, configured to, or operable to support a means for modifying the ML model based on the information. The prediction component 845 is capable of, configured to, or operable to support a means for obtaining a prediction pertaining to the wireless communication link using the modified ML model.

In some examples, the statistical property component 880 is capable of, configured to, or operable to support a means for determining that a statistical property associated with the set of weights satisfies a condition. In some examples, the prediction component 845 is capable of, configured to, or operable to support a means for refraining from obtaining a second prediction pertaining to the wireless communication link using the ML model based on the statistical property satisfying the condition.

In some examples, to support modifying the ML model, the ML model modification component 840 is capable of, configured to, or operable to support a means for switching the ML model from a first ML model associated with the first set of operating conditions to a second ML model associated with the second set of operating conditions based on determining that a statistical property associated with the set of weights satisfies a condition.

In some examples, to support modifying the ML model, the ML model modification component 840 is capable of, configured to, or operable to support a means for training the ML model using a third set of data associated with the second set of operating conditions based at least on part on determining that a statistical property associated with the set of weights satisfies a condition.

In some examples, to support modifying the ML model, the ML model modification component 840 is capable of, configured to, or operable to support a means for re-training the ML model using the set of weights.

In some examples, the weights indication component 835 is capable of, configured to, or operable to support a means for outputting the information to at least one other network node associated with the second set of operating conditions.

In some examples, the weights request component 870 is capable of, configured to, or operable to support a means for outputting a request for weights associated with training the ML model, where obtaining the information is in response to the request.

In some examples, the weights request component 870 is capable of, configured to, or operable to support a means for identifying data drift associated with the ML model, where the data drift corresponds to a difference between the first set of data and the second set of data, and where outputting the request is based on identifying the data drift.

In some examples, the weights request component 870 is capable of, configured to, or operable to support a means for identifying a change in a performance of the ML model within a duration, where outputting the request is based on identifying the change. In some examples, the set of weights are based on data drift associated with the ML model, the data drift corresponding to a difference between the first set of data and the second set of data.

In some examples, the information includes first information indicative of each weight of the set of weights or includes second information indicative of a portion of the set of weights, the portion of the set of weights being associated with a respective portion of the first set of data. In some examples, the information includes first information indicative of statistics corresponding to the set of weights.

In some examples, to support obtaining the information, the statistical property component 880 is capable of, configured to, or operable to support a means for obtaining the information based on a statistical property associated with the set of weights satisfying a condition.

In some examples, to support obtaining the information, the weights indication component 835 is capable of, configured to, or operable to support a means for obtaining the information from a second network node associated with the second set of operating conditions.

In some examples, to support obtaining the information, the weights indication component 835 is capable of, configured to, or operable to support a means for obtaining the information within a duration associated with a handover of the network node from a first cell to a second cell.

In some examples, to support obtaining the information, the metric monitoring component 860 is capable of, configured to, or operable to support a means for obtaining the information based on a metric associated with a performance of the ML model satisfying a threshold.

In some examples, the metric includes a prediction accuracy metric, a system performance metric, or a data distribution metric.

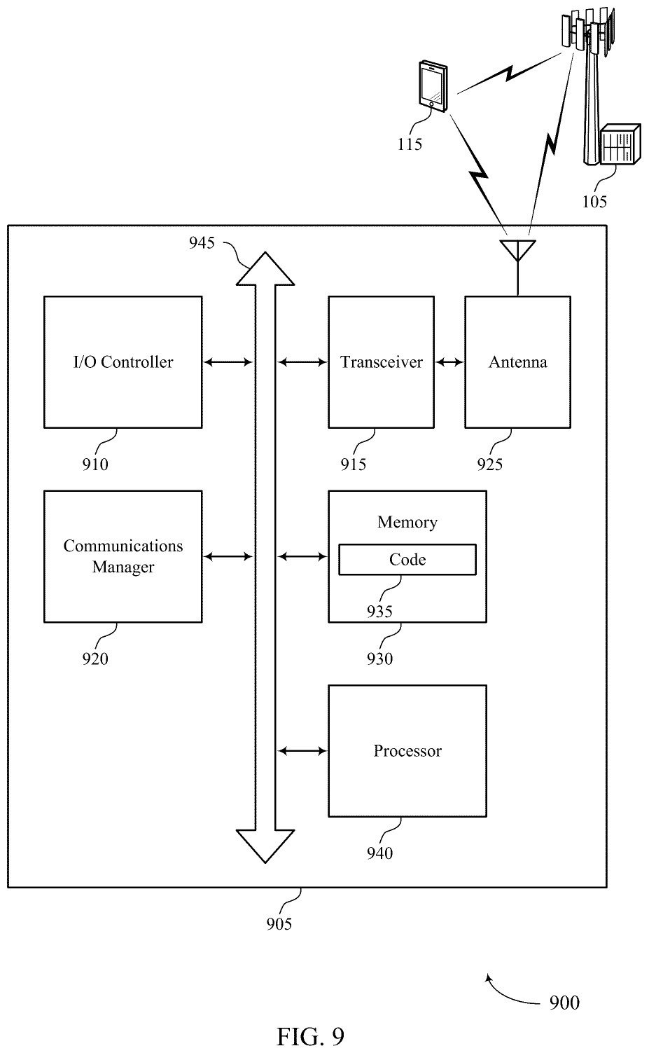

FIG. 9 shows a diagram of a system 900 including a device 905 that supports techniques for modifying ML models using importance weights in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a GPU, and NPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting techniques for modifying ML models using importance weights). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. As such, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

The communications manager 920 may support wireless communication in accordance with examples as disclosed herein. For example, the communications manager 920 is capable of, configured to, or operable to support a means for calculating a set of weights for a first set of data associated with training an ML model in accordance with a first set of operating conditions for maintaining a wireless communication link, where each weight of the set of weights is associated with a respective datum of the first set of data, and where each weight of the set of weights is based on a probability that the respective datum is included in a second set of data, the second set of data being associated with obtaining predictions using the ML model in accordance with a second set of operating conditions for maintaining the wireless communication link. The communications manager 920 is capable of, configured to, or operable to support a means for identifying an event associated with the ML model. The communications manager 920 is capable of, configured to, or operable to support a means for outputting information indicative of the set of weights based on identifying the event.

Additionally, or alternatively, the communications manager 920 may support wireless communication in accordance with examples as disclosed herein. For example, the communications manager 920 is capable of, configured to, or operable to support a means for obtaining information indicative of a set of weights for a first set of data associated with training an ML model in accordance with a first set of operating conditions for maintaining a wireless communication link, where each weight of the set of weights is associated with a respective datum of the first set of data, and where each weight of the set of weights is based on a probability that the respective datum is included in a second set of data, the second set of data being associated with obtaining predictions using the ML model in accordance with a second set of operating conditions for maintaining the wireless communication link. The communications manager 920 is capable of, configured to, or operable to support a means for modifying the ML model based on the information. The communications manager 920 is capable of, configured to, or operable to support a means for obtaining a prediction pertaining to the wireless communication link using the modified ML model.

By including or configuring the communications manager 920 in accordance with examples as described herein, the device 905 may support techniques for improved communication reliability, reduced latency, and more efficient utilization of communication resources.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of techniques for modifying ML models using importance weights as described herein, or the at least one processor 940 and the at least one memory 930 may be otherwise configured to, individually or collectively, perform or support such operations.

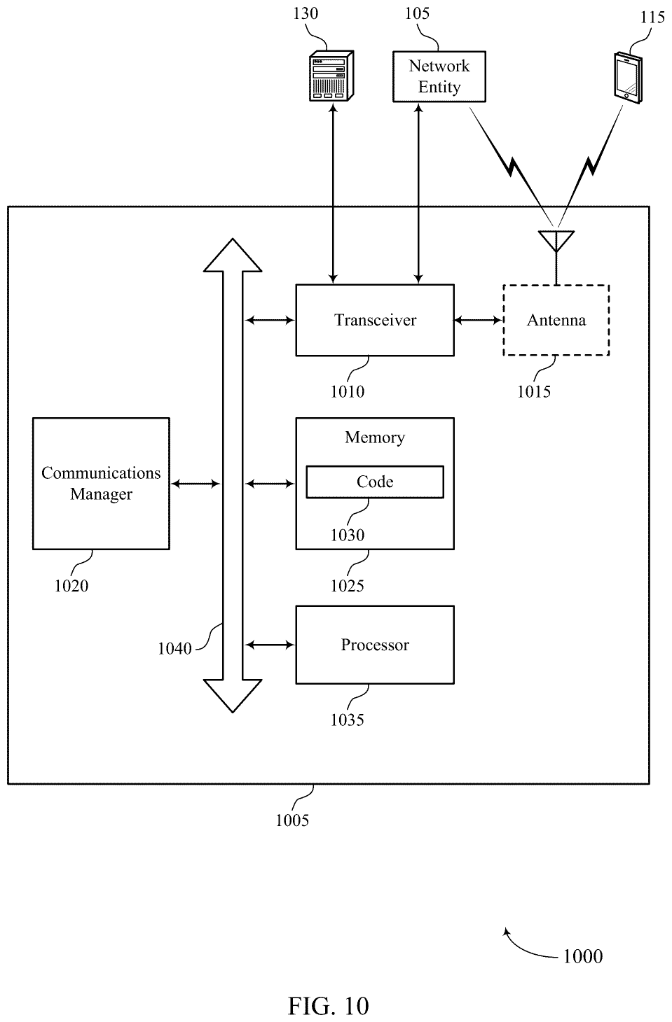

FIG. 10 shows a diagram of a system 1000 including a device 1005 that supports techniques for modifying ML models using importance weights in accordance with one or more aspects of the present disclosure. The device 1005 may be an example of or include the components of a device 605, a device 705, or a network entity 105 as described herein. The device 1005 may communicate with one or more network entities 105, one or more UEs 115, or any combination thereof, which may include communications over one or more wired interfaces, over one or more wireless interfaces, or any combination thereof. The device 1005 may include components that support outputting and obtaining communications, such as a communications manager 1020, a transceiver 1010, an antenna 1015, at least one memory 1025, code 1030, and at least one processor 1035. These components may be in electronic communication or otherwise coupled (e.g., operatively, communicatively, functionally, electronically, electrically) via one or more buses (e.g., a bus 1040).

The transceiver 1010 may support bi-directional communications via wired links, wireless links, or both as described herein. In some examples, the transceiver 1010 may include a wired transceiver and may communicate bi-directionally with another wired transceiver. Additionally, or alternatively, in some examples, the transceiver 1010 may include a wireless transceiver and may communicate bi-directionally with another wireless transceiver. In some examples, the device 1005 may include one or more antennas 1015, which may be capable of transmitting or receiving wireless transmissions (e.g., concurrently). The transceiver 1010 may also include a modem to modulate signals, to provide the modulated signals for transmission (e.g., by one or more antennas 1015, by a wired transmitter), to receive modulated signals (e.g., from one or more antennas 1015, from a wired receiver), and to demodulate signals. In some implementations, the transceiver 1010 may include one or more interfaces, such as one or more interfaces coupled with the one or more antennas 1015 that are configured to support various receiving or obtaining operations, or one or more interfaces coupled with the one or more antennas 1015 that are configured to support various transmitting or outputting operations, or a combination thereof. In some implementations, the transceiver 1010 may include or be configured for coupling with one or more processors or one or more memory components that are operable to perform or support operations based on received or obtained information or signals, or to generate information or other signals for transmission or other outputting, or any combination thereof. In some implementations, the transceiver 1010, or the transceiver 1010 and the one or more antennas 1015, or the transceiver 1010 and the one or more antennas 1015 and one or more processors or one or more memory components (e.g., the at least one processor 1035, the at least one memory 1025, or both), may be included in a chip or chip assembly that is installed in the device 1005. In some examples, the transceiver 1010 may be operable to support communications via one or more communications links (e.g., a communication link 125, a backhaul communication link 120, a midhaul communication link 162, a fronthaul communication link 168).

The at least one memory 1025 may include RAM, ROM, or any combination thereof. The at least one memory 1025 may store computer-readable, computer-executable code 1030 including instructions that, when executed by one or more of the at least one processor 1035, cause the device 1005 to perform various functions described herein. The code 1030 may be stored in a non-transitory computer-readable medium such as system memory or another type of memory. In some cases, the code 1030 may not be directly executable by a processor of the at least one processor 1035 but may cause a computer (e.g., when compiled and executed) to perform functions described herein. In some cases, the at least one memory 1025 may contain, among other things, a BIOS which may control basic hardware or software operation such as the interaction with peripheral components or devices. In some examples, the at least one processor 1035 may include multiple processors and the at least one memory 1025 may include multiple memories. One or more of the multiple processors may be coupled with one or more of the multiple memories which may, individually or collectively, be configured to perform various functions herein (for example, as part of a processing system).

The at least one processor 1035 may include an intelligent hardware device (e.g., a general-purpose processor, a DSP, an ASIC, a CPU, a GPU, an NPU, an FPGA, a microcontroller, a programmable logic device, discrete gate or transistor logic, a discrete hardware component, or any combination thereof). In some cases, the at least one processor 1035 may be configured to operate a memory array using a memory controller. In some other cases, a memory controller may be integrated into one or more of the at least one processor 1035. The at least one processor 1035 may be configured to execute computer-readable instructions stored in a memory (e.g., one or more of the at least one memory 1025) to cause the device 1005 to perform various functions (e.g., functions or tasks supporting techniques for modifying ML models using importance weights). For example, the device 1005 or a component of the device 1005 may include at least one processor 1035 and at least one memory 1025 coupled with one or more of the at least one processor 1035, the at least one processor 1035 and the at least one memory 1025 configured to perform various functions described herein. The at least one processor 1035 may be an example of a cloud-computing platform (e.g., one or more physical nodes and supporting software such as operating systems, virtual machines, or container instances) that may host the functions (e.g., by executing code 1030) to perform the functions of the device 1005. The at least one processor 1035 may be any one or more suitable processors capable of executing scripts or instructions of one or more software programs stored in the device 1005 (such as within one or more of the at least one memory 1025). In some examples, the at least one processor 1035 may include multiple processors and the at least one memory 1025 may include multiple memories. One or more of the multiple processors may be coupled with one or more of the multiple memories, which may, individually or collectively, be configured to perform various functions herein. In some examples, the at least one processor 1035 may be a component of a processing system, which may refer to a system (such as a series) of machines, circuitry (including, for example, one or both of processor circuitry (which may include the at least one processor 1035) and memory circuitry (which may include the at least one memory 1025)), or components, that receives or obtains inputs and processes the inputs to produce, generate, or obtain a set of outputs. The processing system may be configured to perform one or more of the functions described herein. As such, the at least one processor 1035 or a processing system including the at least one processor 1035 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1025 or otherwise, to perform one or more of the functions described herein.

In some examples, a bus 1040 may support communications of (e.g., within) a protocol layer of a protocol stack. In some examples, a bus 1040 may support communications associated with a logical channel of a protocol stack (e.g., between protocol layers of a protocol stack), which may include communications performed within a component of the device 1005, or between different components of the device 1005 that may be co-located or located in different locations (e.g., where the device 1005 may refer to a system in which one or more of the communications manager 1020, the transceiver 1010, the at least one memory 1025, the code 1030, and the at least one processor 1035 may be located in one of the different components or divided between different components).

In some examples, the communications manager 1020 may manage aspects of communications with a core network 130 (e.g., via one or more wired or wireless backhaul links). For example, the communications manager 1020 may manage the transfer of data communications for client devices, such as one or more UEs 115. In some examples, the communications manager 1020 may manage communications with other network entities 105, and may include a controller or scheduler for controlling communications with UEs 115 in cooperation with other network entities 105. In some examples, the communications manager 1020 may support an X2 interface within an LTE/LTE-A wireless communications network technology to provide communication between network entities 105.

The communications manager 1020 may support wireless communication in accordance with examples as disclosed herein. For example, the communications manager 1020 is capable of, configured to, or operable to support a means for calculating a set of weights for a first set of data associated with training an ML model in accordance with a first set of operating conditions for maintaining a wireless communication link, where each weight of the set of weights is associated with a respective datum of the first set of data, and where each weight of the set of weights is based on a probability that the respective datum is included in a second set of data, the second set of data being associated with obtaining predictions using the ML model in accordance with a second set of operating conditions for maintaining the wireless communication link. The communications manager 1020 is capable of, configured to, or operable to support a means for identifying an event associated with the ML model. The communications manager 1020 is capable of, configured to, or operable to support a means for outputting information indicative of the set of weights based on identifying the event.

Additionally, or alternatively, the communications manager 1020 may support wireless communication in accordance with examples as disclosed herein. For example, the communications manager 1020 is capable of, configured to, or operable to support a means for obtaining information indicative of a set of weights for a first set of data associated with training an ML model in accordance with a first set of operating conditions for maintaining a wireless communication link, where each weight of the set of weights is associated with a respective datum of the first set of data, and where each weight of the set of weights is based on a probability that the respective datum is included in a second set of data, the second set of data being associated with obtaining predictions using the ML model in accordance with a second set of operating conditions for maintaining the wireless communication link. The communications manager 1020 is capable of, configured to, or operable to support a means for modifying the ML model based on the information. The communications manager 1020 is capable of, configured to, or operable to support a means for obtaining a prediction pertaining to the wireless communication link using the modified ML model.

By including or configuring the communications manager 1020 in accordance with examples as described herein, the device 1005 may support techniques for improved communication reliability, reduced latency, and more efficient utilization of communication resources.

In some examples, the communications manager 1020 may be configured to perform various operations (e.g., receiving, obtaining, monitoring, outputting, transmitting) using or otherwise in cooperation with the transceiver 1010, the one or more antennas 1015 (e.g., where applicable), or any combination thereof. Although the communications manager 1020 is illustrated as a separate component, in some examples, one or more functions described with reference to the communications manager 1020 may be supported by or performed by the transceiver 1010, one or more of the at least one processor 1035, one or more of the at least one memory 1025, the code 1030, or any combination thereof (for example, by a processing system including at least a portion of the at least one processor 1035, the at least one memory 1025, the code 1030, or any combination thereof). For example, the code 1030 may include instructions executable by one or more of the at least one processor 1035 to cause the device 1005 to perform various aspects of techniques for modifying ML models using importance weights as described herein, or the at least one processor 1035 and the at least one memory 1025 may be otherwise configured to, individually or collectively, perform or support such operations.

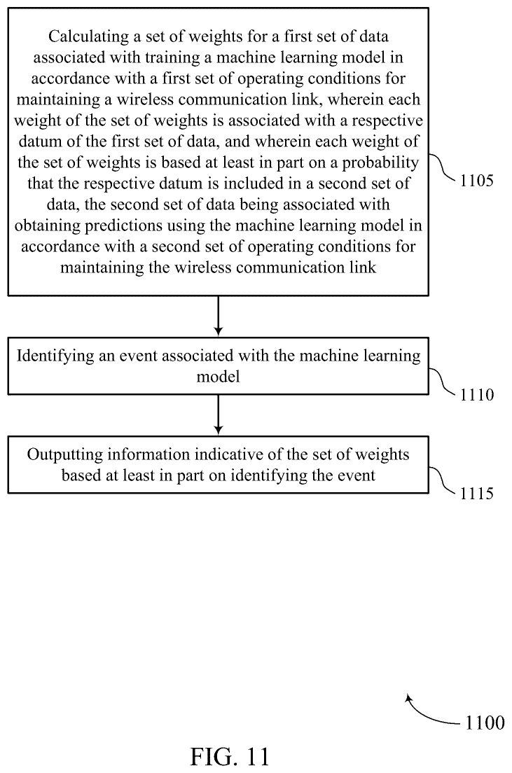

FIG. 11 shows a flowchart illustrating a method 1100 that supports techniques for modifying ML models using importance weights in accordance with aspects of the present disclosure. The operations of the method 1100 may be implemented by a UE or a network entity or its components as described herein. For example, the operations of the method 1100 may be performed by a UE 115 or a network entity as described with reference to FIGS. 1 through 10. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1105, the method may include calculating a set of weights for a first set of data associated with training a machine learning model in accordance with a first set of operating conditions for maintaining a wireless communication link, wherein each weight of the set of weights is associated with a respective datum of the first set of data, and wherein each weight of the set of weights is based at least in part on a probability that the respective datum is included in a second set of data, the second set of data being associated with obtaining predictions using the machine learning model in accordance with a second set of operating conditions for maintaining the wireless communication link. The operations of block 1105 may be performed in accordance with examples as disclosed herein. In some examples, aspects of the operations of 1105 may be performed by an ML model weights component 825 as described with reference to FIG. 8.

At 1110, the method may include identifying an event associated with the machine learning model. The operations of block 1110 may be performed in accordance with examples as disclosed herein. In some examples, aspects of the operations of 1110 may be performed by an event component 830 as described with reference to FIG. 8.

At 1115, the method may include outputting information indicative of the set of weights based at least in part on identifying the event. The operations of block 1115 may be performed in accordance with examples as disclosed herein. In some examples, aspects of the operations of 1115 may be performed by a weights indication component 835 as described with reference to FIG. 8.

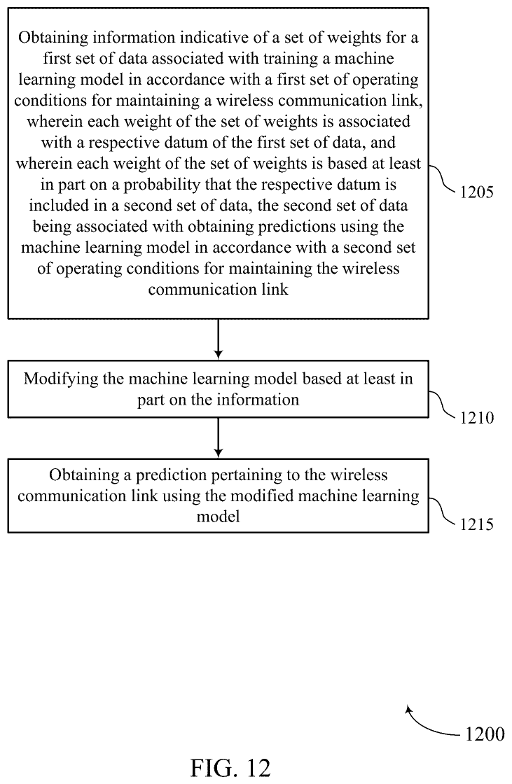

FIG. 12 shows a flowchart illustrating a method 1200 that supports techniques for modifying ML models using importance weights in accordance with aspects of the present disclosure. The operations of the method 1200 may be implemented by a UE or a network entity or its components as described herein. For example, the operations of the method 1200 may be performed by a UE 115 or a network entity as described with reference to FIGS. 1 through 10. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1205, the method may include obtaining information indicative of a set of weights for a first set of data associated with training a machine learning model in accordance with a first set of operating conditions for maintaining a wireless communication link, wherein each weight of the set of weights is associated with a respective datum of the first set of data, and wherein each weight of the set of weights is based at least in part on a probability that the respective datum is included in a second set of data, the second set of data being associated with obtaining predictions using the machine learning model in accordance with a second set of operating conditions for maintaining the wireless communication link. The operations of block 1205 may be performed in accordance with examples as disclosed herein. In some examples, aspects of the operations of 1205 may be performed by an ML model weights component 825 as described with reference to FIG. 8.

At 1210, the method may include modifying the machine learning model based at least in part on the information. The operations of block 1210 may be performed in accordance with examples as disclosed herein. In some examples, aspects of the operations of 1210 may be performed by an ML model modification component 840 as described with reference to FIG. 8.

At 1215, the method may include obtaining a prediction pertaining to the wireless communication link using the modified machine learning model. The operations of block 1215 may be performed in accordance with examples as disclosed herein. In some examples, aspects of the operations of 1215 may be performed by a prediction component 845 as described with reference to FIG. 8.

The following provides an overview of aspects of the present disclosure:

Aspect 1: A method for wireless communication at a network node, comprising: calculating a set of weights for a first set of data associated with training a ML model in accordance with a first set of operating conditions for maintaining a wireless communication link, wherein each weight of the set of weights is associated with a respective datum of the first set of data, and wherein each weight of the set of weights is based at least in part on a probability that the respective datum is included in a second set of data, the second set of data being associated with obtaining predictions using the ML model in accordance with a second set of operating conditions for maintaining the wireless communication link; identifying an event associated with the ML model; and outputting information indicative of the set of weights based at least in part on identifying the event.

Aspect 2: The method of aspect 1, wherein identify the event comprises: identifying data drift associated with the ML model, wherein the data drift corresponds to a difference between the first set of data and the second set of data, and wherein calculating the set of weights is based at least in part on identifying the data drift.

Aspect 3: The method of aspect 2, wherein outputting the information comprises: outputting the information to a UE, wherein the ML model is used at the UE for obtaining the predictions using the ML model.

Aspect 4: The method of aspect 3, wherein the information indicative of the set of weights includes first information indicative of each weight of the set of weights or includes second information indicative of a portion of the set of weights, the portion of the set of weights being associated with a respective portion of the first set of data.

Aspect 5: The method of aspect 3, wherein the information indicative of the set of weights includes first information indicative of statistics corresponding to the set of weights.

Aspect 6: The method of any of aspects 2 through 5, wherein the network node comprises a UE, and the ML model is used at the UE for obtaining the predictions using the ML model.

Aspect 7: The method of aspect 6, wherein outputting the information comprises: outputting the information based at least in part on a statistical property associated with the set of weights satisfying a condition.

Aspect 8: The method of any of aspects 6 through 7, wherein outputting the information comprises: outputting the information to a second UE associated with the second set of operating conditions.

Aspect 9: The method of any of aspects 1 through 8, wherein identify the event comprises: identifying a handover of a UE from a first cell to a second cell, wherein the information is output to the UE within a duration associated with the handover.

Aspect 10: The method of aspect 1, wherein identifying the event comprises: monitoring a metric associated with a performance of the ML model; and determining that the metric satisfies a threshold, wherein calculating the set of weights is based at least in part on the metric satisfying the threshold.

Aspect 11: The method of aspect 10, wherein the metric comprises a prediction accuracy metric, a system performance metric, or a data distribution metric.

Aspect 12: The method of aspect 1, wherein identify the event comprises: obtaining a request for weights associated with training the ML model, wherein outputting the information is in response to obtaining the request.

Aspect 13: The method of any of aspects 1 through 12, further comprising: outputting control signaling comprising a configuration to calculate the set of weights, the configuration indicative of a set of parameters for calculating the set of weights, wherein calculating the set of weights is in accordance with the set of parameters and based on operating conditions for maintaining the wireless communication link.

Aspect 14: The method of aspect 13, wherein the set of parameters are based at least in part on a scheme used for the weight calculations, and the scheme comprises a KDE, a discriminative learning, or a kernel mean matching.

Aspect 15: The method of any of aspects 1 through 12, further comprising: outputting, in response to statistics corresponding to the set of weights exceeding a threshold, control signaling comprising a configuration to: switch from calculating the set of weights associated with the ML model to calculating the set of weights based at least in part on a second ML model or new data, or switch from calculating the set of weights associated with the ML model to calculating the set of weights without using a ML model.

Aspect 16: The method of any of aspects 1 through 12, further comprising: output, in response to statistics corresponding to the set of weights exceeding a threshold, control signaling comprising a configuration to: identify a variation in statistics corresponding to the set of weights, and output control signaling comprising a configuration to calculate the set of weights without a request to collect new data for calculating the set of weights.

Aspect 17: The method of any of aspects 1 through 12, further comprising: obtain a report indicative of a recommendation to recalculate the set of weights, and output the information indicative of the recalculated set of weights based on the recommendation.

Aspect 18: The method of any of aspects 1 through 12, further comprising: outputting control signaling comprising a configuration to calculate the set of weights, the configuration indicative of a set of parameters for calculating the set of weights, where calculating the set of weights is in accordance with the set of parameters and based on operating conditions for maintaining the wireless communication link.

Aspect 19: An apparatus for wireless communications, comprising at least one processor, memory coupled (e.g., operatively, communicatively, functionally, electronically, or electrically) with the at least one processor, and instructions stored in the memory and executable by the at least one processor (e.g., directly, indirectly, after pre-processing, without pre-processing) to cause the apparatus to perform a method of any of aspects 1 through 18.

Aspect 20: A non-transitory computer-readable medium storing code for wireless communications at a UE, the code comprising instructions executable by at least one processor (e.g., directly, indirectly, after pre-processing, without pre-processing) to perform a method of any of aspects 1 through 18.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information, or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network node, comprising:
one or more memories storing processor-executable code; and
one or more processors coupled with the one or more memories and individually or collectively operable to execute the code to cause the network node to:
calculate a set of weights for a first set of data associated with training a machine learning model in accordance with a first set of operating conditions for maintaining a wireless communication link, wherein each weight of the set of weights is associated with a respective datum of the first set of data, and wherein each weight of the set of weights is based at least in part on a probability that the respective datum is included in a second set of data, the second set of data being associated with obtaining predictions using the machine learning model in accordance with a second set of operating conditions for maintaining the wireless communication link;
identify an event associated with the machine learning model; and
output information indicative of the set of weights based at least in part on identifying the event.

2. The network node of claim 1, wherein, to identify the event, the one or more processors are individually or collectively operable to execute the code to cause the network node to:
identify data drift associated with the machine learning model, wherein the data drift corresponds to a difference between the first set of data and the second set of data, and wherein calculating the set of weights is based at least in part on identifying the data drift.

3. The network node of claim 2, wherein, to output the information, the one or more processors are individually or collectively operable to execute the code to cause the network node to:
output the information to a user equipment (UE), wherein the machine learning model is used at the UE for obtaining the predictions using the machine learning model.

4. The network node of claim 3, wherein the information indicative of the set of weights includes first information indicative of each weight of the set of weights or includes second information indicative of a portion of the set of weights, the portion of the set of weights being associated with a respective portion of the first set of data.

5. The network node of claim 3, wherein the information indicative of the set of weights includes first information indicative of statistics corresponding to the set of weights.

6. The network node of claim 2, wherein:
the network node comprises a user equipment (UE), and
the machine learning model is used at the UE for obtaining the predictions using the machine learning model.

7. The network node of claim 6, wherein, to output the information, the one or more processors are individually or collectively operable to execute the code to cause the network node to:
output the information based at least in part on a statistical property associated with the set of weights satisfying a condition.

8. The network node of claim 6, wherein, to output the information, the one or more processors are individually or collectively operable to execute the code to cause the network node to:
output the information to a second UE associated with the second set of operating conditions.

9. The network node of claim 1, wherein, to identify the event, the one or more processors are individually or collectively operable to execute the code to cause the network node to:
identify a handover of a user equipment (UE) from a first cell to a second cell, wherein the information is output to the UE within a duration associated with the handover.

10. The network node of claim 1, wherein, to identify the event, the one or more processors are individually or collectively operable to execute the code to cause the network node to:
monitor a metric associated with a performance of the machine learning model; and
determine that the metric satisfies a threshold, wherein calculating the set of weights is based at least in part on the metric satisfying the threshold.

11. The network node of claim 10, wherein the metric comprises a prediction accuracy metric, a system performance metric, or a data distribution metric.

12. The network node of claim 1, wherein, to identify the event, the one or more processors are individually or collectively operable to execute the code to cause the network node to:
obtain a request for weights associated with training the machine learning model, wherein outputting the information is in response to obtaining the request.

13. The network node of claim 1, wherein the one or more processors are individually or collectively further operable to execute the code to cause the network node to:
output control signaling comprising a configuration to calculate the set of weights, the configuration indicative of a set of parameters for calculating the set of weights, wherein calculating the set of weights is in accordance with the set of parameters and based at least in part on operating conditions for maintaining the wireless communication link.

14. The network node of claim 13, wherein:
the set of parameters are based at least in part on a scheme used for the weight calculations, and
the scheme comprises a kernel density estimation, a discriminative learning, or a kernel mean matching.

15. The network node of claim 1, wherein the one or more processors are individually or collectively further operable to execute the code to cause the network node to:
output, in response to statistics corresponding to the set of weights exceeding a threshold, control signaling comprising a configuration to:
switch from calculating the set of weights associated with the machine learning model to calculating the set of weights based at least in part on a second machine learning model or new data, or
switch from calculating the set of weights associated with the machine learning model to calculating the set of weights without using a machine learning model.

16. The network node of claim 1, wherein, to output the information, the one or more processors are individually or collectively operable to execute the code to cause the network node to:
identify a variation in statistics corresponding to the set of weights; and
output control signaling comprising a configuration to calculate the set of weights without a request to collect new data for calculating the set of weights.

17. The network node of claim 1, wherein the one or more processors are individually or collectively further operable to execute the code to cause the network node to:
obtain a report indicative of a recommendation to recalculate the set of weights; and
output the information indicative of the recalculated set of weights based at least in part on the recommendation.

18. A method for wireless communication at a network node, comprising:
calculating a set of weights for a first set of data associated with training a machine learning model in accordance with a first set of operating conditions for maintaining a wireless communication link, wherein each weight of the set of weights is associated with a respective datum of the first set of data, and wherein each weight of the set of weights is based at least in part on a probability that the respective datum is included in a second set of data, the second set of data being associated with obtaining predictions using the machine learning model in accordance with a second set of operating conditions for maintaining the wireless communication link;
identifying an event associated with the machine learning model; and
outputting information indicative of the set of weights based at least in part on identifying the event.

19. The method of claim 18, further comprising:
outputting control signaling comprising a configuration to calculate the set of weights, the configuration indicative of a set of parameters for calculating the set of weights, wherein calculating the set of weights is in accordance with the set of parameters and based at least in part on operating conditions for maintaining the wireless communication link.

20. A non-transitory computer-readable medium storing code for wireless communication, the code comprising instructions executable by at least one processor to:
calculate a set of weights for a first set of data associated with training a machine learning model in accordance with a first set of operating conditions for maintaining a wireless communication link, wherein each weight of the set of weights is associated with a respective datum of the first set of data, and wherein each weight of the set of weights is based at least in part on a probability that the respective datum is included in a second set of data, the second set of data being associated with obtaining predictions using the machine learning model in accordance with a second set of operating conditions for maintaining the wireless communication link;
identify an event associated with the machine learning model; and
output information indicative of the set of weights based at least in part on identifying the event.
